(19) United States
(12) Patent Application Publication
(10) Pub. No.: US 2008/0176159 A1
(43) Pub. Date: Jul. 24, 2008

(54) TONER, PROCESS CARTRIDGE AND IMAGE FORMING APPARATUS

(76) Inventors: Mitsuyo MATSUMOTO, Ibaraki-shi (JP); Chiyoshi Nozaki, Otsu-shi (JP); Takuya Kadota, Kobe-shi (JP); Katsunori Kurose, Takarazuka-shi (JP); Hiroyuki Murakami, Toyonaka-shi (JP); Tsuyoshi Nozaki, Ikeda-shi (JP); Atsushi Yamamoto, Kawanishi-shi (JP); Yoshimichi Ishikawa, Itami-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/017,853

(22) Filed: Jan. 22, 2008

(30) Foreign Application Priority Data
Jan. 22, 2007 (JP) 2007-011723

(51) Int. Cl. G03G 9/087; G03G 15/08

(52) U.S. Cl. 430/109.4; 430/137.14; 399/262

(57) ABSTRACT

A toner including a coloring material, a binder resin and an external additive, wherein a tensile strength A of a toner agglomeration body compressed at a compression force of 1.1 kgf/cm² is from 10 to 25 gf/cm² and a tensile strength B of a toner agglomeration body compressed at a compression force of 8 kgf/cm² is from 25 to 45 gf/cm² and the tensile strength A and the tensile strength B satisfy the following relationship: (Tensile strength B)−(Tensile strength A)≦25 gf/m².

### BACKGROUND OF THE INVENTION

1. Field of the Invention

The present invention relates to a toner, a method of manufacturing the toner, a toner supply cartridge, a process cartridge, and an image forming apparatus.

2. Discussion of the Background

For a transfer device for use in an image forming apparatus of electrophotography, a system is adopted in which: a transfer roller to which a bias voltage is applied is pressed against an image bearing member; and a toner image on the image bearing member is transferred to a sheet when the sheet passes between the transfer roller and the image bearing member. The transfer device taking this system has advantages such that: transferring a sheet in a bad synchronization and/or image displacement seldom occur; the length of paper path can be shortened; and an image bearing member can be reduced in size, which leads to the size reduction of an image forming apparatus. However, since a toner image on an image bearing member is pressed against a sheet by a transfer roller, the toner is under stress by this pressure. Therefore, the toner tends to agglomerate on the image bearing member, which may cause hollow defects in the transfer image.

As a method of developing a latent electrostatic image, two systems are well known, which are: a two component development system using a mixture of a magnetic carrier and a non-magnetic toner; and a single component development system using no magnetic carrier. The two component development system used to be widely used but recently, the single component system has been popular with the advance of the toner technology. In addition, the single component system does not have to use a carrier and can take a simple and small development system by which stable images can be obtained. However, in the single component system, toner is charged when the toner passes through the pressing gap between a development sleeve and a toner layer regulation blade. At this point, a significant stress is applied to the toner. By this stress, an external additive tends to be embedded in a toner particle and/or toner may crack, resulting in production of toner particles having a small particle diameter. In addition, on the side of the apparatus, a fogging problem on an image bearing member arises due to the attachment of toner to a toner layer regulation blade, and filming of fused toner on a development sleeve stemming from bad charging caused by an insufficient toner thin layer formed on the development sleeve.

To obtain quality images, several attempts have been made to solve the problems mentioned above, for example, adjusting the pressure on a toner image at the transfer point or optimizing the pressure by a toner layer regulation blade in a development device. However, image quality tends to gradually deteriorate while image formation processes are repetitively performed. This is considered to be because the elasticity of a toner layer regulation blade deteriorates and/or the setting of pressure at the transfer point or in a development device becomes out of target while image formation is repeated. In addition, when the pressure to a toner image is optimized at a transfer point for a standard recording sheet, the pressure to a toner image on a recording medium such as a thick paper and an envelope having a significantly different thickness varies at the transfer point. Therefore, it is difficult to form an image with an optimized pressure.

To solve such problems which occur during development or toner image transfer in an image forming apparatus, toner has been improved. For example, unexamined published Japanese patent application No. (hereinafter referred to as JOP) H11-295928 describes a toner which is optimized with regard to attachment stress under pressure, the volume average particle diameter, and the softening point of a binder resin in terms of quantity.

JOP H11-295925 and 2000-3063 describe a toner which is optimized with regard to average circularity, particle diameter distribution, and attachment stress under pressure in terms of quantity.

JOP 2002-169326 describes a toner in which a resin having a specified molecular weight is added to a binder resin and which is specified by the relationship between the volume average particle diameter and the addition amount of an external additive and attachment stress under pressure.

As described above, various kinds of countermeasures have been taken against abnormal images having fogging and hollow defects caused by toner agglomeration and abnormal attachment in a photocopier or a printer to which electrophotography is applied. The technologies described in JOPs H11-295928, H11-295925, 2000-3063 and 2002-169326 have improved toner in some degree but are not sufficient in terms of stability of image formation for an extended period of time.

The present invention is to provide a toner and a method of manufacturing the toner which can reduce production of abnormal images having fogging and hollow defects occurring when images are formed by an image forming apparatus. In addition, a toner supply cartridge, a process cartridge and an image forming apparatus accommodating the toner are also provided.

The present inventors have found that the toner for use in an image forming apparatus is desired to have stable anti-agglomeration property to fluctuation of compressing pressure and, to achieve this, it is important that the attachment stress of toner is stable within a particular range. To be specific, the present inventors have found that, by controlling the attachment stress of a toner compressed at 1.1 kg/cm² corresponding to the compression pressure at a transfer portion and at 8 kg/cm² corresponding to the compression pressure applied when the toner passes through a development sleeve and a toner layer regulation blade, it is possible to obtain a toner which maintains excellent anti-attachment property and can produce images without hollow defects and fogging caused by an image bearing member for an extended period of time. The present invention was thus made.

### SUMMARY OF THE INVENTION

Because of these reasons, the present inventors recognize that a need exists for a toner which maintains excellent anti-attachment property and can produce images without hollow defects and fogging caused by an image bearing member for an extended period of time.

Accordingly, an object of the present invention is to provide a toner which maintains excellent anti-attachment property and can produce images without hollow defects and fogging caused by an image bearing member for an extended period of time. Other objects of the present invention are to provide a method of manufacturing the toner, a toner cartridge, a process cartridge, and an image forming apparatus using the toner. Briefly these objects and other objects of the present invention as hereinafter described will become more readily apparent and can be attained, either individually or in combination thereof, by a toner including a coloring material, a binder resin and an external additive, wherein a tensile strength A of a toner agglomeration body compressed at a compression force of 1.1 kgf/cm² is from 10 to 25 gf/cm² and a tensile strength B of a toner agglomeration body compressed at a compression force of 8 kgf/cm² is from 25 to 45 gf/cm² and the tensile strength A and the tensile strength B satisfy the following relationship: (Tensile strength B)−(Tensile strength A)≦25 gf/m².

It is preferred that, in the toner mentioned above, the binder resin includes a polyester based resin having a glass transition temperature of not lower than 40° C.

It is still further preferred that, in the toner mentioned above, the binder resin includes a polyester resin having at least one of a urea linkage and a urethane linkage in a molecule thereof.

It is still further preferred that, in the toner mentioned above, the binder resin includes a polyester resin formed by reaction between a modified polyester prepolymer having an isocyanate group at an end of a molecular thereof and an amine.

It is still further preferred that the toner mentioned above has an average circularity of from 0.95 to 0.99 and a volume average particle diameter of from 4 to less than 8 μm.

It is still further preferred that the toner mentioned above further includes at least one releasing agent selected from the group consisting of paraffin waxes, synthesized ester waxes, polyolefin waxes, carnauba wax, and rice wax.

It is still further preferred that the toner mentioned above is for a single component development toner.

As another aspect of the present invention, a method of manufacturing the toner mentioned above is provided which includes mixing an oil phase in which at least the coloring agent and at least one of the binder resin and a precursor thereof dissolved or dispersed in an organic solvent in an aqueous medium for granulating particles; and then removing the organic solvent.

It is preferred that the method of manufacturing the toner mentioned above further includes washing the particles with an aqueous medium for washing followed by drying.

As another aspect of the present invention, a process cartridge is provided which includes an image bearing member, a charging device for charging the surface of the image bearing member, and a development device for developing a latent image formed by scanning the surface of the charged image bearing member with light, and the toner supply cartridge of claim 10 is detachably attached to the development device.

As another aspect of the present invention, an image forming apparatus is provided which includes an image bearing member for bearing a latent image on the surface thereof, a charging device for charging the surface of the image bearing member, an irradiation device for irradiating the surface of the image bearing member with light and form the latent image thereon, a development device for developing the latent image with the toner of Claim 1 and visualize the latent image, a transfer device for transferring the visualized image to a recording medium and a cleaning device for cleaning the surface of the image bearing member.

It is preferred that the image forming apparatus mentioned above further includes the toner supply cartridge mentioned above or the process cartridge mentioned above.

It is still further preferred that the image forming apparatus mentioned above includes an intermediate transfer device having an endless form.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a diagram illustrating an embodiment of the image forming apparatus of the present invention; and

FIG. 2 is a diagram illustrating a flow curve of a toner by a flow tester.

### DETAILED DESCRIPTION OF THE INVENTION

The present invention will be described below in detail with reference to several embodiments and accompanying drawings.

The toner of the present invention includes a coloring material (coloring agent), a binder resin and an external additive and a tensile strength A of a toner agglomeration body compressed at a compression force of 1.1 kgf/cm² is from 10 to 25 gf/cm² and preferably from 12 to 18 gf/cm² and a tensile strength B of a toner agglomeration body compressed at a compression force of 8 kgf/cm² is from 25 to 45 gf/cm² and preferably from 30 to 40 gf/cm². In addition, the tensile strength A and the tensile strength B of this toner satisfy the following relationship: Tensile strength B−Tensile strength A≦25 gf/m², preferably from 10 to 20 gf/cm².

In the measurement of the tensile strength of a toner agglomeration body, the reason why the compression pressure for forming a toner agglomeration body is set to be 1.1 kgf/cm² and 8 kgf/cm² is that the compression pressure to a toner at the transfer portion of a typical image forming apparatus is from 0.9 to 1.2 kgf/cm² with an average of 1.1 kgf/cm² and the compression pressure to a toner when the toner passes through the gap between the development sleeve and the toner layer regulation blade in the development device of a typical image forming apparatus is from 7 to 10 kgf/cm² with an average of approximately 8 kgf/cm². Actual toner usage conditions can be recreated by forming an agglomeration body with a compression pressure corresponding thereto. The way a toner is compressed and the measurement of the tensile strength thereof are as follows: place a toner in a test cell; compress the toner to a predetermined pressure at a compression speed of 0.02 mm/sec; hold the predetermined pressure for 300 seconds to form a toner agglomeration body; and measure the tensile rupture strength of this toner agglomeration body as the sample of the tensile strength test. Specific measurement method is described later.

The toner of the present invention hardly produces abnormal images having fogging or hollow defects in the image formation by an image forming apparatus. This is especially true in the single component development system. With regard to the toner of the present invention, the toner has a desired anti-agglomeration property by regulating the attachment stress of the toner at a predetermined pressured state which corresponds to the pressure at a transfer portion or when the toner passes through the gap between the development sleeve and the toner layer regulation blade in a development device. Thereby, it is possible to reduce the occurrence of excessive agglomeration and bad agglomeration at the transfer portion or the toner layer regulation portion in a development device. The toner dissatisfying the relationship mentioned above tends to agglomerate during charging at when the toner passes through the gap between the development sleeve and the toner layer regulation blade. This may cause the attachment of toner to the surface of an image bearing member and a development sleeve or fogging on an image bearing member. This may also cause hollow defects on a transfer image or fogging on an image bearing member when pressed at a transfer portion. In addition, toner may not be sufficiently supplied to a development sleeve, resulting in insufficient formation of a toner image on an image bearing member. This especially has an adverse impact when a single component development system is adopted because a toner thin layer is not formed well on a development sleeve during development, which easily degrades the image quality.

When the tensile strength of a toner agglomeration body of the toner of the present invention formed for a compression pressure of 1.1 kgf/cm² is excessively large, image quality deterioration tends to occur due to fogging. Considering that a toner agglomeration body having too large a tensile strength for a compression pressure of 1.1 kgf/cm² tends to be also excessively large at a compression pressure of 8 kgf/cm² in general, it is inferred that bad charging occurs to toner to be attached to the surface of an image bearing member. It is actually difficult to manufacture a toner having a toner agglomeration body having a small tensile strength, for example, less than 10 gf/cm², at a compression pressure of 1.1 kgf/cm². In addition, a toner having an excessively small tensile strength for a toner agglomeration body tends to produce an image with hollow defects due to bad transfer. When a tensile strength of a toner agglomeration body is small and attachment stress of the toner is too low, the toner may not be sufficiently supplied during charging in a development device so that the uneven transfer easily occur during transfer of a solid image, etc. and thus the image quality tends to deteriorate. In light of this, the tensile strength of a toner agglomeration body of the toner of the present invention compressed at a compression force of 1.1 kgf/cm² is particularly preferable in the range of from 12 to 18 kgf/cm².

In contrast, a tensile strength of a toner agglomeration body of the toner of the present invention formed at a compression pressure of 8 kgf/cm² that is excessively large tends to have an adverse impact on recorded images in terms of fogging and hollow defects. With regard to a toner having a toner agglomeration body having too small a tensile strength at a compression pressure of 8 kgf/cm², toner attachment stress is so weak that the amount of toner supplied during charging is not sufficiently obtained. Therefore, a toner image is not fully formed on an image bearing member, which may lead to the occurrence of hollow defects and uneven transfer due to bad transfer. In light of this, the tensile strength of a toner agglomeration body of the toner of the present invention compressed at a compression force of 8 kgf/cm² is particularly preferable in the range of from 30 to 40 kgf/cm².

When the difference between the tensile strength of a toner agglomeration body of the toner of the present invention compressed at a compression force of 1.1 kgf/cm² and the tensile strength of a toner agglomeration body of the toner of the present invention compressed at a compression force of 8 kgf/cm² is too large, for example, greater than 25 gf/cm², there are adverse impacts on fogging and hollow defects on a recorded image. It seems that a toner having a toner agglomeration body having an agglomeration force varying significantly to the fluctuation of the compression force is not preferred in terms of toner image formation on an image bearing member and image transfer from an image bearing member to a recording medium. In addition, when the difference about the two tensile strengths mentioned above is too small, for example, less than 10 gf/cm², hollow defects tend to occur. Thus, this difference is preferably from 10 to 20 gf/cm².

In the toner of the present invention, the binder resin contained therein can be preferably formed of a polyester resin having a glass transition temperature of not lower than 40° C. When the glass transition temperature of the binder resin is too low, the toner may be fused or softened at a portion other than the fixing device in an image forming apparatus. It is more preferred that the binder resin contains a polyester resin having a urea linkage and/or a urethane linkage in its molecule. This binder resin is also preferred to have a polyester resin formed by reaction between a modified polyester prepolymer having an isocyanate group at its molecular end and an amine.

The toner of the present invention has an average circularity of from 0.95 to 0.99, preferably from 0.96 to 0.99 and more preferably from 0.97 to 0.99 and has a volume average particle diameter of from 4 to less than 8 μm. A toner having a high average circularity is preferred in terms of fluidity but 0.99 is the upper limit considering the economy of toner manufacturing.

In general, an external additive is an additive for improving the dispersability and fluidity of a toner. When such an external additive is mixed with a toner material, it is preferred that the external additive is evenly but not strongly fixed on the surface of a toner material particle as a target particle. As such an external additive, inorganic particulate are preferably used. This inorganic particulate preferably has a primary particle diameter of from 5 to 100 mμ and particularly preferably from 5 to 50 mμ. The content of this inorganic particulate is preferably from 0.1 to 5.0% by weight and more preferably from 0.5 to 3% by weight based on the content of a toner. With regard to the hardness of the binder resin, T1/2 is preferably not lower than 120° C. and more preferably not lower than 125° C.

The toner of the present invention preferably includes at least one releasing agent and/or charge control agent selected from the group consisting of paraffin waxes, synthetic ester waxes, polyolefin waxes, carnauba wax and rice wax.

### Toner Supply Cartridge

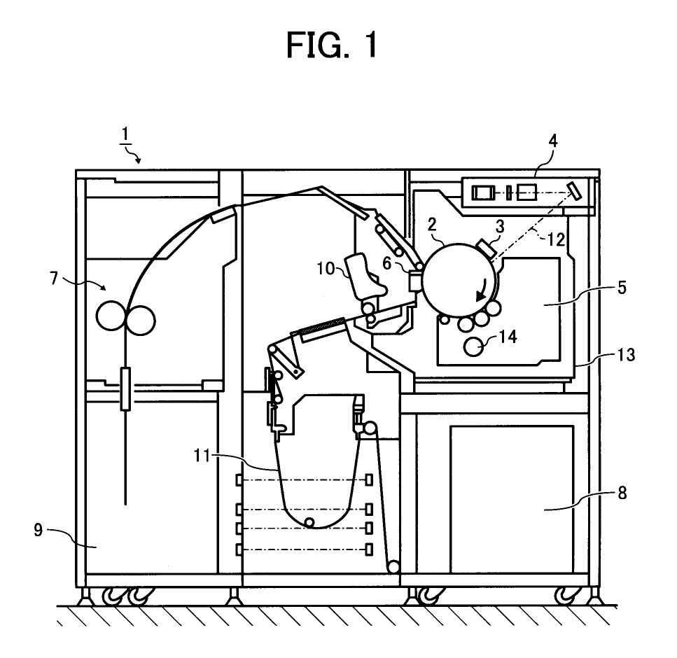

The toner supply cartridge of the present invention is a toner supply cartridge which is detachably attached to an image forming apparatus for electrophotography and supplies the toner of the present invention to a toner transfer portion of a development device for forming a toner image on the surface of an image bearing member of the image forming apparatus. As illustrated in FIG. 1, this image forming apparatus 1 for electrophotography has at least: a rotatable image bearing member 2; a charging device 3 that charges the surface of the image bearing member 2 to a predetermined voltage; an optical scanning device 4 that forms a latent image by irradiating the surface of the image bearing member 2 with light signals; a development device 5 that conveys a toner to the surface of the image bearing member 2 and develops the latent image thereon with the toner; a transfer device 6 that transfers the toner image formed on the image bearing member 2 to a recording medium (paper) 11; a fixing device 7 that fixes the transferred image on the recording medium 11; and a toner supply cartridge 14 that accommodates and supplies the toner of the present invention to the toner transfer portion of the development device 5. The image forming apparatus 1 having the toner supply cartridge 14 can produce quality images without trouble such as fogging and hollow defects.

### Process Cartridge

With regard to the image forming apparatus described above, the process cartridge of the present invention integrally unites the image bearing member 2 and at least one of the charging device 3 and the development device 5 as a process cartridge 13 and is detachably attached to the main body of the image forming apparatus 1 (e.g., a photocopier and a printer). The process cartridge 13 in the image forming apparatus 1 illustrated in FIG. 1 has the image bearing member 2, the charging device 3 and the development device 5 having a toner transfer member and the toner supply cartridge 14. The toner of the present invention has no trouble such as fogging and hollow defects with regard to image formation and can produce quality images. Therefore, the process cartridge of the present invention is suitably used for an image forming apparatus for electrophotography.

### Image Forming Apparatus

As illustrated in FIG. 1, the image forming apparatus of the present invention has at least: the rotatable image bearing member 2; the charging device 3 that charges the surface of the image bearing member 2 to a predetermined voltage; the optical scanning device 4 that forms a latent image by irradiating the surface of the image bearing member 2 with light signals; the development device 5 that conveys a toner to the surface of the image bearing member 2 and forms a toner image from the latent image; the transfer device 6 that transfers the toner image formed on the image bearing member 2 to the recording medium (paper) 11; and the fixing device 7 that fixes the transferred image on the recording medium 11. The toner container provided in the development device 5 can accommodate the toner of the present invention. The toner of the present invention has no trouble such as fogging and hollow defects with regard to image formation and can produce quality images. Therefore, the image forming apparatus of the present invention is suitably used.

The image forming apparatus of the present invention can be preferably applied to an image forming apparatus for multi-color printing such as two color or three color printing or a full color printing in addition to a single color printing in which a single image formation portion mainly formed of an image bearing member is used.

In the image forming apparatus of the present invention, images are formed by the following processes: a latent image formation process that forms a latent image on an image bearing member; a toner image formation process that develops the latent image with the toner of the present invention to form a toner image; a transfer process that transfers the developed toner image to a transfer body such as a recording medium; and a fixing process that fixes the toner image transferred to the transfer body. With reference to FIG. 1, the image formation method in the present invention is specifically described in relation to the operation of the image forming apparatus and the process cartridge of the present invention. In the image forming apparatus 1 illustrated in FIG. 1, the image bearing member 2 is rotationally driven at a predetermined linear speed. The surface of the image bearing member 2 is uniformly charged with a negative or positive polarity having a predetermined voltage by the charging device 3 while the image bearing member 2 is in the rotation process. Next, the image bearing member 2 receives image irradiation signals 12 such as slit irradiation or laser beam scanning irradiation from the optical scanning device 4. Thus, a latent electrostatic image is formed on the surface of the image bearing member 2. The formed latent electrostatic image is developed with the toner of the present invention supplied from the toner supply cartridge 14 in the development device 5. These are the operations of the process cartridge 13. In FIG. 1, the process cartridge 13 is used but it is not necessary to use a package device such as the process cartridge 13.

Next, the developed toner image is transferred to the recording medium 11 conveyed from the paper feeder to between the image bearing member 2 and the transfer device 6 in synchronization with the rotation of the image bearing member 2. When transferred from the image bearing member 2 to the recording medium 11, it is possible to transfer the toner image to the recording medium 11 via an intermediate transfer device such as an endless transfer belt. In the case of image formation for multi-color printing, a vivid color image can be easily obtained without color displacement by using this intermediate transfer belt.

The recording medium 11 to which the toner image has been transferred is separated from the surface of the image bearing member 2 and transferred to the fixing device 7, where the toner image is fixed. The recording medium 11 on which the toner image has been fixed is transferred to a printed material storing portion 9 or printed out of the image forming apparatus 1 as a photocopy or a print. The fixing device 7 has a heating device and preferably includes a pressing roller or a pressing belt. Typically, a combination of a preliminary heating portion for a recording material with a heating roller and a pressing roller, or a preliminary heating portion for a recording material with a heating roller and a pressing belt is used. In addition, it is preferred to use an oil-free fixing device which does not use lubricating oil on the contact surface between the fixing device 7 and the recording material 11.

The surface of the image bearing member 2 after image transfer is cleared of transfer residual toner by a cleaning device. The image bearing member 2 is then discharged and readied for the next image formation. In the image forming apparatus of the present invention, the toner for use therein does not cause unintentional agglomeration or shortage of agglomeration. Therefore, the amount of toner that unnecessarily remains on an image bearing member and an intermediate transfer belt is reduced. Therefore, the image forming apparatus can dispense with a cleaning blade for use in cleaning the surface of an image bearing member and an intermediate transfer belt. In addition, when a cleaning blade is provided, there is no need to provide a blade cleaning device that cleans the cleaning blade.

### Toner and Method of Manufacturing Toner

The method of manufacturing the toner of the present invention is briefly described below. The toner is obtained by: dissolving or dispersing at least a prepolymer as a precursor of a polyester based resin and/or a modified polyester based resin and a material containing a toner composition in an organic solvent; conducting a cross-linking reaction and/or an elongation reaction of the prepolymer in an aqueous medium; and removing the solvent from the obtained liquid dispersion. To obtain the toner, it is preferred to dissolve or disperse at least a polyester resin (which can include a prepolymer as a precursor of a modified polyester based resin) as a binder resin, a material containing a toner composition and/or a radical generation agent in an organic solvent, emulsify or disperse a dissolved or dispersed material (hereinafter referred to as oil phase) under the presence of the radical generation agent in an aqueous medium and remove the solvent therefrom. The known portion about this method of manufacturing a toner in this embodiment is, for example, is well understood with reference to the dissolution suspension method in the method of manufacturing a toner for use in an image forming apparatus for electrophotography described in Article 41 in Vol. 43 of Journal of Imaging Society of Japan (published in 2004). Below is a detailed description of the method of manufacturing a toner in this embodiment.

### 1. Material for Oil Phase

### (1) Polyester-Based Resin

As the binder resin for use in the toner of the present invention, it is preferable to use a polyester based resin having no vinyl polymerizable group. As the polyester based resin, known polyester based resin such as modified polyester resins having a urea linkage or a urethane linkage formed of a polyester prepolymer having an isocyanate group and an amine, and non-modified polyester resins can be used. The non-modified polyester resin means a polyester resin having no urea linkage or urethane linkage. These can be used in alone or in combination.

### (2) Modified Polyester Resin

In the manufacturing of a binder resin for use in the toner of the present invention, it is possible to use a polyester prepolymer having an isocyanate group as a modified polyester resin precursor. Preferably, a polyester prepolymer having an isocyanate group at its end can be used. In addition, it is also possible to use a polyester prepolymer having multiple isocyanate groups, especially 3 or more isocyanate groups. Specific examples of polyester prepolymers (A) having an isocyanate group include, but are not limited to, a resultant of the reaction between polyisocyanate (3) and a polyester, i.e., a polycondensation compound having an active hydrogen group which is prepared by polyol (1) and polycarboxylic acid (2). Specific examples of the active hydrogen group contained in the polyesters mentioned above include, but are not limited to, hydroxyl groups (alcohol hydroxyl groups and phenol hydroxyl groups), amino groups, carboxylic groups, and mercarpto groups. Among these, alcohol hydroxyl groups are particularly preferred.

### Polyols

Specific examples of the polyols (1) include, but are not limited to, alkylene glycol (e.g., ethylene glycol, 1,2-propylene glycol, 1,3-propylene glycol, 1,4-butanediol and 1,6-hexanediol); alkylene ether glycols (e.g., diethylene glycol, triethylene glycol, dipropylene glycol, polyethylene glycol, polypropylene glycol and polytetramethylene ether glycol); alicyclic diols (e.g., 1,4-cyclohexane dimethanol and hydrogenated bisphenol A); bisphenols (e.g., bisphenol A, bisphenol F, bisphenol S and 4,4′-dihydroxybiphenyls such as 3,3′-difluoro-4,4′-dihydroxybiphenyl); bis(hydroxyphenyl)alkanes (e.g., bis(3-fluoro-4-hydroxyphenyl)ethane, 2,2-bis(3-fluoro-4-hydroxyphenyl)propane, 2,2-bis(3,5-difluoro-4-hydroxyphenyl)propane (aka tetrafluoro bisphenol A) and 2,2-bis (3-hydroxyphenyl)-1,1,1,3,3,3-hexafluoro propane; adducts of the alicyclic diols mentioned above with an alkylene oxide (e.g., ethylene oxide, propylene oxide and butylene oxide); and adducts of the bisphenols mentioned above with an alkylene oxide (e.g., ethylene oxide, propylene oxide and butylene oxide); etc.

Among these compounds, alkylene glycols having from 2 to 12 carbon atoms and adducts of a bisphenol with an alkylene oxide are preferable. More preferably, adducts of a bisphenol with an alkylene oxide, or mixtures of an adduct of a bisphenol with an alkylene oxide and an alkylene glycol having from 2 to 12 carbon atoms are used. Furthermore, aliphatic alcohols having three or more hydroxyl groups (e.g., glycerin, trimethylol ethane, trimethylol propane, pentaerythritol and sorbitol); polyphenols having three or more hydroxyl groups (trisphenol PA, phenol novolak and cresol novolak); adducts of the polyphenols mentioned above with an alkylene oxide; etc. can be included. The polyols can be used alone or in combination.

### Polycarboxylic Acid

Specific examples of the polycarboxylic acids (2) include, but are not limited to, alkylene dicarboxylic acids (e.g., succinic acid, adipic acid and sebacic acid); alkenylene dicarboxylic acids (e.g., maleic acid and fumaric acid); aromatic dicarboxylic acids (e.g., phthalic acid, isophthalic acid, terephthalic acid and naphthalene dicarboxylic acids, 3-fluoroisophtalic acid, 2-fluoroisophthalic acid, 2-fluoroterephthalic acid, 2,4,5,6-tetrafluoroisophthalic acid, 2,3,5,6-tetrafluoroterephthalic acid, 5-trifluoromethyl isophthalic acid, 2,2-bis(4-carboxyphenyl)hexafluoropropane, 2,2-bis(3-carboxyphenyl)hexafluoropropane, 2,2-bis(trifluoromethyl)-4,4′-biphenyl dicarboxylic acid, 3,3′-bis(trifluoromethyl-4,4′-biphenyl dicarboxylic acid, 2,2-bis(trifluoromethyl)-3,3′-biphenyl dicarboxylic acid, and an anhydride of hexafluoroisopropylidene diphthalic acid; etc.

Among these compounds, alkenylene dicarboxylic acids having from 4 to 20 carbon atoms and aromatic dicarboxylic acids having from 8 to 20 carbon atoms are preferably used.

Specific examples of the polycarboxylic acids having three or more hydroxyl groups include, but are not limited to, aromatic polycarboxylic acids having 9 to 20 carbon atoms (e.g., trimellitic acid and pyromellitic acid).

Also, resultants of reaction between an anhydride or lower alkyl esters (e.g., methyl esters, ethyl esters or isopropyl esters) of the polycarboxylic acids mentioned above and a polyol (1) can be used. These polycarboxylic acids can be used alone or in combination.

### Ratio of Polyol and Polycarboxylic Acid

A suitable mixing ratio (i.e., an equivalence ratio [OH]/[COOH]) of a polyol (1) to a polycarboxylic acid (2) is from 2/1 to 1/1, preferably from 1.5/1 to 1/1 and more preferably from 1.3/1 to 1.02/1.

### Polyisocyanate

Specific examples of the polyisocyanates (3) include, but are not limited to, aliphatic polyisocyanates (e.g., tetramethylene diisocyanate, hexamethylene diisocyanate and 2,6-diisocyanate methylcaproate); alicyclic polyisocyanates (e.g., isophorone diisocyanate and cyclohexylmethane diisocyanate); aromatic diisosycantes (e.g., tolylene diisocyanate and diphenylmethane diisocyanate); aromatic aliphatic diisocyanates (e.g., α, α, α′, α′-tetramethyl xylylene diisocyanate); isocyanurates; blocked polyisocyanates in which the polyisocyanates mentioned above are blocked with phenol derivatives thereof, oximes or caprolactams; etc. These compounds can be used alone or in combination.

### Ratio of Isocyanate Group to Hydroxyl Group

Suitable mixing ratio (i.e., [NCO]/[OH]) of a polyisocyanate (3) to a polyester having a hydroxyl group is from 5/1 to 1/1, preferably from 4/1 to 1.2/1 and more preferably from 2.5/1 to 1.5/1. When the [NCO]/[OH] ratio is too large, the low temperature fixability of the toner deteriorates. When the molar ratio of [NCO] is too small, the urea content of a modified polyester tends to be small and the anti-hot offset property deteriorates.

The content of the constitutional component of a polyisocyanate (PIC) in the polyester prepolymer (A) having a polyisocyanate group at its end portion is from 0.5 to 40% by weight, preferably from 1 to 30% by weight and more preferably from 2 to 20% by weight. When the content is too low, the hot offset resistance of the toner deteriorates and in addition the heat resistance preservability and low temperature fixability of the toner also deteriorate. In contrast, when the content is too high, the low temperature fixability of the toner deteriorates.

### Number of Isocyanate Groups in Prepolymer

The number of isocyanate groups included in the prepolymer (A) per molecule is not less than 1 on average, preferably from 1.5 to 3, and more preferably from 1.8 to 2.5. When the number of isocyanate groups is too small, the molecular weight of the modified polyester obtained after cross-linking reaction and/or elongation reaction tends to be small and the anti-hot offset property deteriorates.

### Cross Linking Agent and Elongation Agent

In the cross linking reaction and/or elongation reaction of a prepolymer, an amine can be used as a cross linking agent and/or an elongation agent. Specific examples of the amines (B) include, but are not limited to, diamines (B1), polyamines (B2) having three or more amino groups, amino alcohols (B3), amino mercaptans (B4), amino acids (B5), and blocked amines (B6), in which the amino groups in the amines (B1-B5) mentioned above are blocked.

Specific examples of the diamines (B1) include, but are not limited to, aromatic diamines (e.g., phenylene diamine, diethyltoluene diamine, 4,4′-diaminodiphenyl methane, tetrafluoro-p-xylylene diamine, and tetrafluoro-p-phenylene diamine); alicyclic diamines (e.g., 4,4′-diamino-3,3′-dimethyldicyclohexyl methane, diaminocyclohexane and isophoron diamine); aliphatic diamines (e.g., ethylene diamine, tetramethylene diamine, hexamethylene diamine, dodecafluorohexylene diamine, and tetracosafluorododecylene diamine); etc.

Specific examples of the polyamines (B2) having three or more amino groups include, but are not limited to, diethylene triamine, and triethylene tetramine.

Specific examples of the amino alcohols (B3) include, but are not limited to, ethanol amine, diethanol amine and hydroxyethyl aniline.

Specific examples of the amino mercaptan (B4) include, but are not limited to, aminoethyl mercaptan and aminopropyl mercaptan.

Specific examples of the amino acids (B5) include, but are not limited to, amino propionic acid and amino caproic acid.

Specific examples of the blocked amines (B6) include, but are not limited to, ketimine compounds which are prepared by reacting one of the amines B1-B5 mentioned above with a ketone such as acetone, methyl ethyl ketone and methyl isobutyl ketone; oxazoline compounds, etc.

Among these compounds, diamines (B1) and mixtures in which a diamine (B1) is mixed with a small amount of a three or higher valent polyamine (B2) are preferred.

### Molecular Weight Control Agent

Furthermore, the molecular weight of the modified polyesters after the cross linking reaction and/or the elongation reaction can be controlled by using a molecular-weight control agent, if desired. Specific preferred examples of the molecular-weight control agent include, but are not limited to, monoamines (e.g., diethyl amine, dibutyl amine, butyl amine and lauryl amine), and blocked amines (i.e., ketimine compounds) prepared by blocking the monoamines mentioned above.

### Ratio of Amino Group and Isocyanate Group

The mixing ratio of the isocyanate group to the amines (B), i.e., the equivalent ratio ([NCO]/[NHx]) of the isocyanate group [NCO] contained in the prepolymer (A) to the amino group [NHx] contained in the amines (B), is normally from 1/2 to 2/1, preferably from 1.5/1 to 1/1.5 and more preferably from 1.2/1 to 1/1.2. When the mixing ratio is too large or too small, the molecular weight of the resultant urea-modified polyester (i) decreases, resulting in deterioration of the hot offset resistance of the resultant toner.

### Non-modified Polyester Resin

As the polyester based resin in the toner of the present invention, a modified polyester resin (A) can be used alone. However, it is preferred to contain a non-modified polyester resin (C) with this modified polyester resin (A) as a toner binder component. By using the non-modified polyester resin (C) in combination, the low temperature fixing property is improved and also the gloss property is improved when such a binder resin is used for a full color apparatus. As the non-modified polyester resin (C), the polycondensation of the polyol (1) and polycarboxylic acid (2) described above for the polyester composition of the modified polyester resin (A) can be used. Preferred examples thereof are the same as those for the polyester composition of the modified polyester resin (A)

The non-modified polyester resin (C) includes the totally non-modified polyester resins and the polyester resins modified by a chemical linkage other than urea linkage and urethane linkage. Namely, the modified polyester resin (A) means the polyester resin modified by urea linkage and urethane linkage and the non-modified polyester resin (C) means the polyester resin having no urea linkage or urethane linkage. It is preferred that the modified polyester resin (A) at least partially mixes with the non-modified polyester (C) in terms of improvement on the low temperature fixability and hot offset resistance of a resultant toner. Therefore, the modified polyester resin (A) preferably has a structure similar to that of the non-modified polyester resin (C).

The mixing ratio of the modified polyester resin (A) to the non-modified polyester resin (ii) varies from 5/95 to 75/25, preferably from 10/90 to 25/75, more preferably from 12/88 to 25/75, and even more preferably from 12/88 to 22/78. When the addition amount of the modified polyester resin (A) is too small, the hot offset resistance of a resultant toner deteriorates and, in addition, it is difficult to impart a good combination of high temperature preservability and low temperature fixability to the resultant toner.

### Molecular Weight of Non-modified Polyester Resin (C)

The peak weight average molecular weight of the non-modified polyester resin (C) is normally from 1,000 to 30,000, preferably from 1,500 to 10,000, and more preferably from 2,000 to 8,000. When the peak molecular weight is too small, the high temperature preservability tends to deteriorate. When the peak molecular weight is too large, the low temperature fixability tends to deteriorate. The hydroxyl group value of the non-modified polyester resin (C) is preferably not less than 5 mgKOH/g, more preferably from 10 to 120 mgKOH/g and even more preferably 20 to 80 mgKOH/g. When the hydroxyl group value of the non-modified polyester (C) is too low, it is disadvantageous to achieve a good combination of high temperature preservability and low temperature fixability. The acid value of the non-modified polyester resin (C) is normally from 0.5 to 40 mgKOH/g, and preferably from 5 to 35 mgKOH/g. By having an acid value, a resultant toner tends to be negatively charged. In addition, when the acid value and the hydroxyl value are not within the range, a toner having such an acid value and a hydroxyl value is vulnerable to the influence of the environment of high temperature and high humidity or low temperature and low humidity, which easily causes deterioration of image quality.

Suitable colorants (coloring material) for use in the toner of the present invention include known dyes and pigments. Specific examples of the colorants include, but are not limited to, carbon black, Nigrosine dyes, black iron oxide, Naphthol Yellow S, Hansa Yellow (10G, 5G and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red F5R, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These materials can be used alone or in combination. The content of the colorant is from 1 to 15% by weight and preferably from 3 to 10% by weight based on the toner.

### Coloring Material As Master Batch

Master batch pigments, which are prepared by combining a colorant with a resin, can be used as the colorant of the toner composition of the present invention. Specific examples of the resins for use in the master batch pigments or for use in combination with master batch pigments include, but are not limited to, the modified polyester resins and the unmodified polyester resins mentioned above; styrene polymers and substituted styrene polymers such as polystyrene, poly-p-chlorostyrene and polyvinyltoluene; styrene copolymers such as styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers; and other resins such as polymethyl methacrylate, polybutyl methacrylate, polyvinyl chloride, polyvinyl acetate, polyethylene, polypropylene, polyesters, epoxy resins, epoxy polyol resins, polyurethane resins, polyamide resins, polyvinyl butyral resins, acrylic resins, rosin, modified rosins, terpene resins, aliphatic or alicyclic hydrocarbon resins, aromatic petroleum resins, chlorinated paraffin, paraffin waxes, etc. These resins can be used alone or in combination. Method of Manufacturing Master Batch

The master batch for use in the toner of the present invention is typically prepared by mixing and kneading a resin and a colorant upon application of high shear stress thereto. In this case, an organic solvent can be used to boost the interaction of the colorant with the resin. In addition, flushing methods in which an aqueous paste including a colorant is mixed with a resin solution of an organic solvent to transfer the colorant to the resin solution and then the aqueous liquid and organic solvent are separated to be removed can be preferably used because the resultant wet cake of the colorant can be used as it is. In this case, three-roll mills can be preferably used for kneading the mixture upon application of high shear stress thereto. Furthermore, to improve dispersability and solubility of an oil phase to a solvent during preparation of the oil phase, it is possible to use this master batch as a liquid dispersion or solution (wet master) of an organic solvent for the oil phase.

### Wax (Releasing Agent)

A release agent (wax) may be included in the toner of the present invention in addition to the binder resins and coloring agents (coloring materials). Suitable release agents include known waxes described in, for example, “Characteristics of wax and its application”, second edition, authored by Kenzo Fusegawa, published by Saiwai Shobo. Specific examples thereof include, but are not limited to, polyolefin waxes such as polyethylene waxes and polypropylene waxes; paraffins such as paraffin waxes and SAZOL wax; synthetic ester waxes such as trimethylolpropane tribehenate, pentaerythritol tetrabehenate, pentaerythritol diacetate dibehenate, glycerin tribehenate, 1,18-octadecanediol distearate, trimellitic acid tristearyl, distearyl maleate and octadecyl stearate; natural vegetable waxes such as carnauba wax, rice wax and candelilla wax; natural mineral based wax such as montan wax, ozocerite and ceresin; and aliphatic acid amide based synthetic wax such as stearic acid amide. Among these, polyolefins, paraffins, synthetic ester waxes, carnauba wax, and rice wax are preferred. These can be used alone or in combination.

The content of the wax in a toner is from 2 to 30% by weight and preferably from 4 to 15% by weight based on 100% by weight of the resin component. When the content of a wax is excessively small, the wax oozes on the surface of a fixing device during fixing so that the toner is prevented from being attached to the fixing device but the wax may not be able to exhibit the release effect due to its small amount depending on the kind of the wax. This may narrow the margin for anti-hot offset. In addition, these waxes melt at a low temperature and are easily affected by thermal energy and mechanical energy. Therefore, when the content of a wax having a low melting point is excessively large and the wax is for use in a two component developing agent, the wax may be detached from the surface of toner particles during stirring with carriers and attach to a toner layer regulation blade and an image bearing member, which leads to image noise. When used in a single component developing agent, the toner may attached to the blade at a development regulation portion, which causes image noise.

In addition, the endotherm peak of the wax measured by a differential scanning calorimeter (DSC) while the temperature is on the rise is from 65 to 115° C. and thus the toner containing the wax can be fixed at a low temperature. When the melting point of a wax is too low, the fluidity of the toner tends to deteriorate. When the melting point of a wax is too high, the fixing property tends to deteriorate.

### Wax Dispersion Agent

To have wax around the surface of toner particles, a wax dispersion agent is used. As such a wax dispersion agent, it is preferred to use a monomer for a toner binder resin which is hardly soluble in water during toner emulsification and the polymerized compound of which is not or hardly compatible with a wax. Wax can be controlled to be located on or near the surface of toner particles by dispersing and polymerizing this wax dispersion agent in an amount of 50 to 200% by weight based on that of the wax.

For the binder resin for a toner which hardly affiliates to water, monomers for use in a typical binder resin for a toner can be used. Specific examples thereof include, but are not limited to, styrene-based monomer such as styrene, a-methyl styrene, p-methyl styrene, m-methyl styrene, p-methoxy styrene, p-hydroxy styrene, p-acetoxy styrene, vinyl toluene, ethyl styrene, phenyl styrene and benzil styrene; alkyl (having 1 to 18 carbon atoms) esters of an unsaturated carboxylic acid such as methyl(meth)acrylate, ethyl(meth)acrylate, butyl(meth)acrylate, and 2-ethylhexyl (meth) acrylate, vinyl ester based monomers such as vinyl acetate, Vinyl ether based monomers such as vinyl methylether, halogenated vinyl based monomer such as vinyl chloride, dien based monomers such as butadiene and isobutylene, and unsaturated nitrile based monomers such as (meth)acrylonitrile and cyanostyrene. These can be used alone or in combination.

When a wax is wet-pulverized and finely dispersed, it is preferred to add a wax dispersion agent to improve the dispersability. There is no specific limit to selection of such a wax dispersion agent. The basic concept of selecting a suitable wax dispersion agent is that a material having a portion having a high affinity to wax and a portion having a high affinity to a binder resin should be selected. For example, a compound in which a copolymer of styrene-(meth)acrylate is grafted to a polyethylene wax is suitably used. There is no specific limit to the content of this wax dispersion agent to a toner and the content is arbitrarily determined depending on purpose. The content of a wax dispersion agent is from 1 to 200 parts by weight based on 100 parts by weight of a wax.

### Organic Solvent of Oil Phase

The toner of the present invention is prepared by: dissolving or dispersing a toner composition containing a polyester as a binder resin and a coloring material in an organic solvent; emulsifying or dispersing the lysate or dispersion material in an aqueous medium containing a radical generation agent under the presence of an inorganic dispersion agent or resin particulates; and removing the solvent. It is preferred that the polyester resin as a binder resin does not contain a vinyl polymerization group.

The organic solvent that dissolves or disperses a toner composition formed of a polyester resin and a coloring agent has a Hansen dissolution parameter of not greater than 19.5. The Hansen dissolution parameter is described in, for example, Section VII in Volume 2 of “Polymer Handbook” 4^{th} edition published by Wiley-Interscience. Considering that the solvent is removed, the boiling point of the solvent is preferably lower than 150° C. Specific examples of such organic solvents include, but are not limited to, hexane, cyclohexane, toluene, xylene, benzene, carbon tetrachloride, 1,1,1-trichloroethane, trichloroethylene, chloroform, methyl acetate, ethyl acetate, butyl acetate, methylethyl ketone and tetrahydrofuran. These can be used alone or in combination.

### Material for use in Aqueous Medium

### Aqueous Medium

Methods of manufacturing the toner of the present invention are described below.

Suitable aqueous media for use in the present invention include water, and mixtures of water with a solvent which can be mixed with water. Specific examples of such a solvent include alcohols (e.g., methanol, isopropanol and ethylene glycol), dimethylformamide, tetrahydrofuran, cellosolves (e.g., methyl cellosolve), lower ketones (e.g., acetone and methyl ethyl ketone), etc. Furthermore, an organic solvent mentioned above for use in the oil phase having a Hansen dissolution parameter of not greater than 19.5 can be mixed. When such an organic solvent is added to water in an amount close to the saturation amount, the emulsification or dispersion stability of an oil phase added to an aqueous medium can be improved. The amount of an aqueous medium is normally from 50 to 2,000 parts by weight and preferably from 100 to 1,000 parts by weight based on 100 parts by weight of a toner composition. When the amount of an aqueous medium is too small, the dispersion stability of a toner composition is degraded so that toner particles having a desired particle diameter are not obtained. An amount of an aqueous medium that is excessively large is not preferred in light of economy.

### Radical Generation Agent

A radical generation agent is added to an aqueous medium. There is no specific limit to selection of such a radical generation agent added to an aqueous medium as long as the radical generation agent is dispersed or dissolved in the aqueous medium. Such a radical generation agent can be used alone or in combination. A combination of an oxidation agent and a reduction agent utilizing oxidation-reduction reaction is also allowed. The addition amount of a radical generation agent is adjusted to a toner solid portion depending on the kind of the radical generation agent and granulation temperature and is normally from 0.1 to 20% by weight and preferably from 0.5 to 10% by weight.

As the radical generation agent, it is possible to use an agent known as a polymerization initiator. For example, the polymerization initiators described in Section II in Volume 1 of “Polymer Handbook” 4^{th} edition published by Wiley-Interscience can be used. The radical generation agent can be added to an oil phase and/or an aqueous phase. An oil soluble polymerization initiator is preferably used when added to an oil phase and a water soluble polymerization initiator is preferably used when added to an aqueous phase.

Specific examples of such oil soluble polymerization initiators include, but are not limited to, azo based or diazo based polymerization initiators such as 2,2′-bisazo-(2,4-dimethyl valeronitrile), 2,2′-azobisisobutylonitrile, 1,1-azobis(cyclohexane-l-carbonitrile), 2,2′-azobis-4-methoxy-2,4-dimethylvaleronitrile and azobis sobutylonitrile; peroxide based polymerization initiators such as benzoyl peroxide, methylethylketone peroxide, diisopropylperoxycarbonate, cumene hydroperoxide, t-butylhydroperoxide, di-t-butylperoxide, dicumyl peroxide, 2,4-dichlorobenzoyl peroxide, lauroyl peroxide, 2,2-bis-(4,4-t-butyl peroxy cyclohexyl)propane, and tris-(t-butylperoxy)triazine; and polymerization initiators having peroxides in its branch chain.

Specific examples of water-soluble polymerization initiators include, but are not limited to, persulfate salts such as potassium persulfate and ammonium persulfate, 2,2′-azobis(2-methylpropion amidine dihydrochloride, 2,2′-azobis[N-(2-carboxyethyl)-2-methylpropion amidine], 4,4′azobis(4-cyanovalericacid azobis aminodipropane acetate, azobiscyano valeric acid and its salt, and hydrogen peroxide.

### Inorganic Dispersion Agent

In an aqueous medium, lysate or dispersion material of a toner composition is dispersed under the presence of an inorganic dispersion agent or resin particulates. Specific examples of the inorganic dispersion agent include, but are not limited to, tricalcium phosphate, calcium carbonate, titanium oxide, colloidal silica and hydroxyapatite. Using a dispersion agent is preferable in terms that the particle size distribution is sharp and the dispersion is stable.

### Particulate Resin

It is preferred to add resin particulates to the toner of the present invention in addition to a binder resin. There is no specific limit to selection of resins that form resin particulates as long as the resin can form a dispersion body in an aqueous medium. A dispersion body having fine spherical resin particulates is preferred. Thermoplastic resins or thermocuring resins can be used as resin particulates. Specific examples thereof include, but are not limited to, vinyl based resins, polyurethane resins, epoxy resins, polyester resins, polyamide resins, polyimide resins, silicon based resins, phenol resins, melamine resins, urea resins, aniline resins, ionomer resins, and polycarbonate resins. These resins can be used alone or in combination. Among these, vinyl resins, polyurethane resins, epoxy resins and polyester resins and their combinational use are preferred in terms that a dispersion body having fine spherical resin particulates is easy to obtain.

### Vinyl Based Resin

Vinyl based resins are polymers formed by monopolymerizing or copolymerizing a vinyl based monomer. Specific examples of the vinyl based monomers include, but are not limited to, the following compounds of (a) to (e).

### (a) Vinyl Based Hydrocarbon

Aliphatic vinyl based hydrocarbons: alkenes such as ethylene, propylene, butane, isobutylene, pentene, heptene, diisobutylene, octane, dodecene, octadecene, α-olefins other than the above mentioned; alkadiens such as butadiene, isoplene, 1,4-pentadiene, 1,6-hexadiene, 1,7-octadiene, etc.

Alicyclic vinyl based hydrocarbons: mono- or di-cycloalkenes and alkadiens such as cyclohexene, (di)cyclopentadiene, vinylcyclohexene, and ethylidene bicycloheptene; and terpenes such as pinene, limonene, indene, etc.

Aromatic vinyl-based hydrocarbons: styrene and its hydrocarbyl (alkyl, cycloalkyl, aralkyl and/or alkenyl) substitutes, such as α-methylstyrene, vinyl toluene, 2,4-dimethylstyrene, ethylstyrene, isopropyl styrene, butyl styrene, phenyl styrene, cyclohexyl styrene, benzyl styrene, crotyl benzene, divinyl benzene, divinyl toluene, divinyl xylene, and trivinyl benzene; and vinyl naphthalene, etc.

### (b) Vinyl Based Monomer Containing Carboxyl Group and its Salts

Unsaturated mono carboxylic acid and unsaturated dicarboxylic acid having 3 to 30 carbon atoms, and their anhydrides and their monoalkyl (having 1 to 24 carbon atoms) esters, such as vinyl based monomers having carboxylic group such as (meth)acrylic acid, (anhydride of) maleic acid, mono alkyl esters of maleic acid, fumaric acid, mono alkyl esters of fumaric acid, crotonic acid, itoconic acid, mono alkyl esters of itaconic acid, glycol monoether of itaconic acid, citraconic acid, mono alkyl esters of citraconic acid, cinnamic acid, etc.

(C) Vinyl Based Monomer Having Sulfonic Group, Monoesterified Vinyl Based Sulfuric Acid and their Salts

Alkene sulfuric acid having 2 to 14 carbon atoms such as vinyl sulfuric acid, (meth) aryl sulfuric acid, methylvinylsufuric acid and styrene sulfuric acid; their alkyl delivatives having 2 to 24 carbon atoms such as α-methylstyrene sulfuric acid; sulfo(hydroxyl)alkyl-(meth)acrylate or (meth)acryl amide such as sulfopropyl(meth)acrylate, 2-hydroxy-3-(meth)acryloxy propylsulfuric acid, 2-(meth)acryloylamino-2,2-dimethylethane sulfuric acid, 2-(meth)acryloyloxyethane sulfuric acid, 3-(meth)acryloyloxy-2-hydroxypropane sulfuric acid, 2-(meth)acrylamide-2-methylpropane sulfuric acid, 3-(meth) avrylamide-2-hydroxy propane sulfuric acid, alkyl (having 3 to 18 carbon atoms) aryl sulfosuccinic acid, sulfuric esters of poly(n=2 to 30) oxyalkylene (ethylene, propylene, butylenes: (mono, random, block) mono(meth)acrylate such as sulfuric acid ester of poly (n=5 to 15) oxypropylene monomethacrylate, sulfuric acid ester of polyoxyethylene polycyclic phenyl ether, etc.

### (d) Vinyl Based Monomer Having Phosphoric Group and its Salts

Phosphoric acid monoester of (meth) acryloyl oxyalkyl such as 2-hydroxyethyl(meth)acryloyl phosphate, phenyl-2-acyloyloxyethylphosphate, (meth) acryloyloxyalkyl (having 1 to 24 carbon atoms) phosphonic acids such as 2-acryloyloxy ethylphosphonic acid and their salts, etc.

Specific examples of the salts of the compounds of (b) to (d) include, but are not limited to, alkali metal salts (sodium salts, potassium salts, etc.), alkali earth metal salts (calcium salts, magnesium salts, etc.), ammonium salts, amine salts, quaternary ammonium salts, etc.

### (e) Vinyl Based Monomer Having Hydroxyl Group

Hydroxystyrene, N-methylol(meth)acryl amide, hydroxyethyl(meth)acrylate, (meth)arylalcohol, crotyl alcohol, isocrotyl alcohol, 1-butene-3-ol, 2-butene-1-ol, 2-butene-1,4-diol, propargyl alcohol, 2-hydroxyethylpropenyl ether, simple sugar aryl ether, etc.

### (f) Vinyl Based Monomer Having Nitrogen

Vinyl based monomer having an amino group: aminoethyl(meth)acrylate, dimethylaminoethyl(meth)acrylate, diethylaminoethyl(meth)acrylate, t-butylaminoethyl(meth)acrylate, N-aminoethyl(meth)acrylamide, (metha)arylamine, morpholino ethyl (meth) acrylate, 4-vinylpyridine, 2-vinylpyridine, crotyl amine, N,N-dimethylaminostyrene, methyl-α-acetoaminoacrylate, vinylimidazole, N-vinylpyrrole, N-vinylthiopyrolidone, N-arylphenylene diamine, aminocarbozole, aminothiazole, aminoindole, aminopyrrole, aminoimidazole, aminomercaptothiazole and their salts, etc.

Vinyl Based Monomer Having Amide Group: (meth)acrylamide, N-methyl (meth) acrylamide, N-butylacrylamide, diacetone acrylamide, N-methylol(meth)acrylamide, N,N-methylene-bis(meth)acrylamide, cinnamic amide, NmN-dimethylacrylamide, N,N-dibenzylacrylamide, methacrylformamide, N-methyl-N-vinylacetoamide, N-vinylpyrolidone, etc.

Vinyl Based Monomer Having Nitrile Group: (meth) acrylonitrile, cyanostyrene and cyanoacrylate.

Vinyl Based Monomer Having Quaternary Ammonium Group: quaternarized vinyl based monomer having tertiary amine group such as dimethylaminoethyl(meth)acrylate, diethylaminoethyl(meth)acrylate, dimethylaminoethyl(meth)acrylamide, diethylaminoethyl (meth) acrylamide, diarylamine, etc. (quaternaized by using a quaternarizing agent such as methylchloride, dimethyl sulfuric acid, benzyl chloride, dimethylcarbonate).

Vinyl Based Monomer Having Nitro Group: nitrostyrene, etc.

### (g) Vinyl Based Monomer Having Epoxy Group

Glycidyl (meth)acrylate, tetrahydrofurfuryl(meth)acrylate, p-vinylphenyl phenyloxide, etc.

### (h) Vinyl Esters, Vinyl(thio)ether, Vinylketone, Vinyl Sulfonic Acid

Vinyl esters: Vinyl acetate, vinyl butylate, vinyl propionate, vinyl butyrate, diarylphthalate, diaryladipate, isopropenyl acetate, vinylmethacrylate, methyl-4-vinylbenzoate, cyclohexylmethacrylate, benzylmethacrylate, phenyl(meth)acrylate, vinylmethoxyacetate, vinylbenzoate, ethyl-a-ethoxyacrylate, alkyl (having 1 to 50 carbon atoms) (meth)acrylate such as methyl(meth)acrylate, ethyl(meth)acrylate, propyl(meth)acrylate, butyl(meth)acrylate, 2-ethylhexyl(meth)acrylate, dodecyl(meth)acrylate, hexadecyl(meth)acrylate, heptadecyl(meth)acrylate, and eicocyl(meth)acrylate), dialkyl malate (in which two alkyl groups are straight chained, branch chained, or cyclic chained groups and have 2 to 8 carbon atoms), poly (meth) aryloxyalkanes such as diaryloxyethane, triaryloxyethane, tetraaryloxyethane, tetraaryloxypropane, tetraaryloxybutane and tetrametharyloxyethane, vinyl based monomers having polyalkylene glycol chain such as polyethylene glycol (molecular weight: 300) mono(meth)acrylate, polypropylene glycol (molecular weight: 500) monoacrylate, adducts of (meth) acrylate with 10 mol of methylalcoholethyleneoxide, and adducts of (meth) acrylate with 30 mol of lauryl alcohol ethylene oxide), poly(meth)acrylates such as poly (meth) acrylates of polyhydroxyl alcohols (e.g., ethylene glycol di(meth)acrylate, propylene glycol di(meth)acrylate, neopentylglycol di(meth)acrylate, trimethylol propane tri(meth)acrylate, and polyethylene glycol di(meth)acrylate).

Vinyl(thio)ethers: vinylmethyl ether, vinylethyl ether, vinylpropyl ether, vinylbutyl ether, vinyl-2-ethylhexyl ether, vinylphneyl ether, vinyl-2-methoxyethyl ether, methoxy butadiene, vinyl-2-buthxyethyl ether, 3,4-dihydro-1,2-pyrane, 2-buthoxy-2′-vinyloxy diethyl ether, vinyl-2-ethylmercapto ethylether, acetoxystyrene and phenoxy styrene.

Vinyl ketones: vinyl methylketone, vinylethylketone, vinyl phenylketone, etc.

Vinyl sulfone: divinyl sulfide, p-vinyl diphenyl sulfide, vinyl ethylsulfide, vinyl ethylsulfone, divinyl sulfone, divinyl sulfoxide, etc.

### (i) Other Vinyl Based Monomer

Isocyanate ethyl(meth)acrylat, m-isopropenyl-α,α-dimethylbenzyl isocyanate, etc.

### (j) Vinyl Based Monomer Having Fluorine Atom

4-fluorostyrene, 2,3,5,6-tetrafluorostyrene, pentafluorophenyl(meth)acrylate, pentafluorobenzyl(meth)acrylate, perfluorocyclohexyl(meth)acrylate, perfluorocyclohexylmethyl(meth)acrylate, 2,2,2-trifluoroethyl(meth)acrylate, 2,2,3,3-tetrafluoropropyl(meth)acrylate, 1H,1H,4H-hexafluorobutyl(meth)acrylate, 1H,1H,4H-hexafluorobutyl(meth)acrylate, 1H,1H,5H-ocatafluoropentyl(meth)acrylate, 1H,1H,7H-dodecafluoroheptyl(meth)acrylate, perflurooctyl(meth)acrylate, 2-perfluorooctylethyl(meth)acrylate, heptadecafluorodecyl(meth)acrylate, trihydroperfluoroundecyl(meth)acrylate, perfluoronorbonyl(meth)acrylate, 1H-perfluoroisobornyl(meth)acrylate, 2-(N-butylperfluorooctane sulfone amide)ethyl(meth)acrylate, 2-(N-ethylperfluorooctane sulfone amide)ethyl(meth)acrylate, and derivatives introduced from α-fluoroacrylic acid.

Bis-hexafluoroiso propyl itaconate, bis-hexafluoro isopropyl malate, bis-perfluorooctyl itaconate, bis-perfluorooctyl malate, bis-trifluoroethyl itaconate, bis-trifluoroethyl malate, etc.

Vinylheptafluorobutylate, vinyl perfluoroheptanoate, vinyl perfluoro nonanoate and vinyl perfluoro octanoate, etc.

### b) Vinyl Based Copolymer

As copolymers of a vinyl based monomer, copolymerized polymers formed of any two or more monomers of the compounds of (a) to (j) in an arbitral ratio can be used. Specific examples thereof include, but are not limited to, ester copolymers of styrene and (meth) acrylic acid, styrene-butadiene copolymers, ester copolymers of (meth)acrylic acid and acrylic acid, copolymers of styrene and acrylonitrile, copolymers of styrene and anhydride of malaic acid, copolymers of styrene and (meth) acrylic acid, copolymers of styrene and (meth) acrylic acid and divinyl benzene, and ester copolymers of styrene, styrene sulfonic acid and (meth)acrylic acid. Any one or more monomers of (a) to (j) compounds mentioned above are copolymerized in an arbitral ratio.

### Monomer Ratio of Vinyl Based Resin

To form resin particulates in the dispersion body mentioned above, the resins mentioned above is desired to be not dissolved in water completely at least under the conditions for forming a dispersion body. Therefore, when a vinyl-based resin is a copolymer, the ratio of a hydrophobic monomer to a hydrophilic monomer forming the vinyl based resin depends on the selection of the monomers but is generally preferable that a hydrophobic monomer is not less than 10% and more preferably not less than 30%. When the ratio of a hydrophobic monomer is too small, the obtained vinyl resin is water soluble so that the uniformity of the toner particle diameter is not obtained. The hydrophilic monomer means a monomer that is dissolved in water in any ratio. The hydrophobic monomer means the other polymers (monomer that does not actually form a uniform phase).

### Method of Dispersing Resin Particulate in Aqueous Medium

There is no specific limit to the method of preparing an aqueous liquid dispersion of resin particulates from a resin. For example, the following methods of (a) to (h) can be used.
(a) A method of manufacturing an aqueous liquid dispersion of resin particulate directly from the polymerization reaction by a suspension polymerization method, an emulsification polymerization method, a seed polymerization method or a dispersion polymerization method from a monomer as the start material in the case of a vinyl based resin.
(b) A method of manufacturing an aqueous liquid dispersion of resin particulates by dispersing a precursor (monomer, oligomer, etc.) or its solvent solution under the presence of a suitable dispersion agent and curing the resultant by heating and/or adding a curing agent in the case of a polyaddition or polycondensation resin such as a polyester resin, a polyurethane resin and an epoxy resin.
(c) In the case of a polyaddition or polycondensation resin such as a polyester resin, a polyurethane resin and an epoxy resin, a method of manufacturing an aqueous liquid dispersion of resin particulates by dissolving a suitable emulsification agent in a precursor (monomer, oligomer, etc.) or its solvent solution (liquid is preferred, e.g., liquidized by heating) followed by adding water for phase change.
(d) A method of manufacturing an aqueous liquid dispersion of resin particulates by fine-pulverizing resins preliminarily manufactured by a polymer reaction (addition polymerization, ring scission polymerization, polyaddition, addition condensation, polycondensation, etc.) with a fine grinding mill of a mechanical rotation type or jet type, classifying the resultant, and dispersing the obtained resin particulates in water under the presence of a suitable dispersion agent.
(e) A method of manufacturing an aqueous liquid dispersion of resin particulates by spraying in the form of a fine liquid mist a resin solution in which resins preliminarily manufactured by a polymer reaction (addition polymerization, ring scission polymerization, polyaddition, addition condensation, polycondensation, etc.) are dissolved in a solvent and dispersing the obtained resin particulates in water under the presence of a suitable dispersion agent.
(f) A method of manufacturing an aqueous liquid dispersion of resin particulates by: precipitating resin particulates by adding a solvent to a resin solution in which resins preliminarily manufactured by a polymer reaction (addition polymerization, ring scission polymerization, polyaddition, addition condensation, polycondensation, etc.) are dissolved in another solvent or cooling the resin solution preliminarily prepared by heating and dissolving in a solvent; removing the solvent to obtain the resin particulates; and dispersing the obtained resin particulates in water under the presence of a suitable dispersion agent.
(g) A method of manufacturing an aqueous liquid dispersion of resin particulates by dispersing in an aqueous medium a resin solution in which resins preliminarily manufactured by a polymer reaction (addition polymerization, ring scission polymerization, polyaddition, addition condensation, polycondensation, etc.) are dissolved in a solvent under the presence of a suitable dispersion agent and removing the solvent by heating or reducing pressure.
(h) A method of manufacturing an aqueous liquid dispersion of resin particulates by dissolving a suitable emulsification agent in a resin solution in which resins preliminarily manufactured by a polymer reaction (addition polymerization, ring scission polymerization, polyaddition, addition condensation, polycondensation, etc.) are dissolved in a solvent and adding water for phase change.

### Particle Diameter of Resin Particulate

The particle diameter of resin particulates is normally smaller than that of a toner particle. In terms of uniformity of particle diameter, the ratio (volume average particle diameter of resin particulate to volume average particle diameter of toner particle) particle diameters of resin particulate to toner particle is preferable in the range of from 0.001 to 0.3. When this particle diameter ratio is too large, resin particulates tend to be not efficiently attached to the surface of toner particles and thus the particle size distribution of the obtained toner tends to be wide. The volume average particle diameter of resin particulates can be suitably adjusted to be in the range mentioned above so that a toner having a desired particle diameter is obtained. For example, to obtain a toner having a volume average particle diameter of 5 μm, the particle diameter of resin particulate is preferably from 0.0025 to 1.5 μm and more preferably from 0.005 to 1.0 μm. To obtain a toner having a volume average particle diameter of 10 μm, the particle diameter of resin particulate is preferably from 0.005 to 3.0 μm and more preferably from 0.05 to 2.0 μm. The volume average particle diameter can be measured by a laser Doppler type particle size measuring device (UPA-150, manufactured by Nikkiso Co., Ltd.), a laser type particle size measuring device (LA-920, manufactured by Horiba, Ltd.) or a MULTISIZER II (manufactured by Beckman Coulter Co., Ltd.).

### Surface Active Agent

To emulsify and/or disperse an oil phase containing a toner composition in an aqueous medium, it is possible to use a surface active agent, if desired. Specific examples of the surface active agents include, but are not limited to, anionic dispersion agents, for example, alkylbenzene sulfonic acid salts, α-olefin sulfonic acid salts, and phosphoric acid salts; cationic dispersion agents, for example, amine salts (e.g., alkyl amine salts, aminoalcohol fatty acid derivatives, polyamine fatty acid derivatives and imidazoline), and quaternary ammonium salts (e.g., alkyltrimethyl ammonium salts, dialkyldimethyl ammonium salts, alkyldimethyl benzyl ammonium salts, pyridinium salts, alkyl isoquinolinium salts and benzethonium chloride); nonionic dispersion agents, for example, fatty acid amide derivatives, polyhydric alcohol derivatives; and ampholytic dispersion agents, for example, alanine, dodecyldi(aminoethyl)glycin, di)octylaminoethyle)glycin, and N-alkyl-N,N-dimethylammonium betaine.

A good dispersion can be prepared with an extremely small amount of a surface active agent having a fluoroalkyl group. Preferred specific examples of the anionic surface active agents having a fluoroalkyl group include, but are not limited to, fluoroalkyl carboxylic acids having from 2 to 10 carbon atoms and their metal salts, disodium perfluorooctanesulfonylglutamate, sodium 3-{omega-fluoroalkyl(C6-C11)oxy}-1-alkyl(C3-C4) sulfonate, sodium 3-{omega-fluoroalkanoyl(C6-C8)-N-ethylamino}-1-propanesulfonate, fluoroalkyl(C11-C20) carboxylic acids and their metal salts, perfluoroalkylcarboxylic acids and their metal salts, perfluoroalkyl(C4-C12)sulfonate and their metal salts, perfluorooctanesulfonic acid diethanol amides, N-propyl-N-(2-hydroxyethyl)perfluorooctanesulfone amide, perfluoroalkyl(C6-C10)sulfoneamidepropyltrimethylammonium salts, salts of perfluoroalkyl(C6-C10)-N-ethylsulfonyl glycin, monoperfluoroalkyl(C6-C16)ethylphosphates, etc. Specific examples of the cationic surface active agents having a fluoroalkyl group include, but are not limited to, primary and secondary aliphatic amino acids, secondary amino acids, aliphatic quaternary ammonium salts (for example, perfluoroalkyl(C6-C10)sulfoneamidepropyltrimethyl ammonium salts), benzalkonium salts, benzetonium chloride, pyridinium salts, and imidazolinium salts.

### Protective Colloid

It is possible to stabilize liquid droplet dispersion in an aqueous medium using a polymeric protection colloid. Specific examples of such polymeric protection colloids include, but are not limited to, polymers and copolymers prepared using monomers, for example, acids (e.g., acrylic acid, methacrylic acid, α-cyanoacrylic acid, α-cyanomethacrylic acid, itaconic acid, crotonic acid, fumaric acid, maleic acid and maleic anhydride), acrylic monomers having a hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, N-methylolacrylamide and N-methylolmethacrylamide), vinyl alcohol and its ethers (e.g., vinyl methyl ether, vinyl ethyl ether and vinyl propyl ether), esters of vinyl alcohol with a compound having a carboxyl group (i.e., vinyl acetate, vinyl propionate and vinyl butyrate); acrylic amides (e.g, acrylamide, methacrylamide and diacetoneacrylamide) and their methylol compounds, acid chlorides (e.g., acrylic acid chloride and methacrylic acid chloride), and monomers having a nitrogen atom or an alicyclic ring having a nitrogen atom (e.g., vinyl pyridine, vinyl pyrrolidone, vinyl imidazole and ethylene imine).

In addition, polymers, for example, polyoxyethylene compounds (e.g., polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters), and cellulose compounds, for example, methyl cellulose, hydroxyethyl cellulose and hydroxypropyl cellulose, can also be used as the polymeric protective colloid. When compounds, for example, calcium phosphate, which are soluble in an acid or alkali, are used as a dispersion stabilizer, it is possible to dissolve the calcium phosphate by adding an acid, for example, hydrochloric acid, followed by washing of the resultant particles with water, to remove the calcium phosphate from particulates. In addition, a zymolytic method can be used to remove such compounds. There is no problem in that such a dispersion agent may remain on the surface of toner particles. However, it is preferred to wash and remove the dispersion agent after elongation and/or cross-linking reaction in terms of charging toner particles.

### Dispersion and Emulsification Method

There is no particular restriction for the dispersion and emulsification method. Low speed shearing methods, high speed shearing methods, friction methods, high pressure jet methods, ultrasonic methods, etc., can preferably be used. Among these methods, high speed shearing methods are more preferred because particles having a particle diameter of from 2 to 20 μm can be easily prepared. When a high speed shearing type dispersion machine is used, there is no particular limit to the rotation speed thereof, but the rotation speed is typically from 1,000 to 30,000 rpm, and preferably from 5,000 to 20,000 rpm. The dispersion time is also not particularly limited, but is typically from 0.1 to 5 minutes for a batch production method. The temperature in the dispersion process is typically from 0 to 150° C. (under pressure), and preferably from 20 to 90° C. The dispersion process is preferably performed at a high temperature because the dispersion body containing a toner composition containing a polyester resin has a low viscosity at a high temperature and thus the dispersion can be easily performed.

To accelerate generation of radicals from the radical generation agent mentioned above, it is preferred to suitably provide heat considering the heat decomposition half life period temperature thereof. The temperature during dispersion can be selected from the range of from 20 to 90°C. In addition, during the process after dispersion to the process of removing a solvent, which is described later, heating can be conducted on suitable occasions.

### Elongation Reaction

When a binder resin is, for example, a urea-modified polyester resin from a polyester prepolymer, it is possible to mix an amine and a sulfonication agent in an oil phase and conduct a reaction with a prepolymer before dispersing a toner component in an aqueous medium or disperse a toner composition in an aqueous medium and add an amine thereto to conduct a reaction from particle interfaces. In the latter case, urea-modified polyester resins are preferentially generated on the surface of manufactured toner part and concentration gradient of the urea-modified polyester resin inside the particle is obtained. The time to be taken for the polyaddition reaction mentioned above is determined by the isocyante structure having a polyester prepolymer and the reaction property of the added amine and is normally from 1 minute to 40 hours and preferably from 1 to 24 hours. The reaction temperature is normally from 0 to 150° C., and preferably from 20 to 98° C. Known catalysts can be used, if desired. Specific examples thereof include, but are not limited to, dibutyltin laurate and dioctyltin laurate.

### Removing Solvent

To remove an organic solvent from the obtained emulsified dispersion body, it is possible to use a method in which the temperature of the system is gradually raised to completely remove and evaporate the organic solvent in droplets. It is also possible to spray an emulsified dispersion body in a dry atmosphere to completely remove water insoluble organic solvent and form toner particulates while evaporating and removing an aqueous dispersion agent. The dry atmosphere in which an emulsified dispersion body is sprayed is heated air, nitrogen gas, carboxylic acid gas and combustion gas. Especially, various kinds of air streams heated to a temperature higher than the highest boiling point of the solvents are used. A toner having target quality can be obtained even by a short time treatment by a spray drier, a belt drier, a rotary kiln, etc.

### Wet Classification

The toner has a wide particle size distribution during emulsification and dispersion. When such a toner is subject to washing and drying treatment, it is preferred to adjust the particle size distribution by classifying to a desired particle size distribution. Classification can be performed in liquid by using a cyclone, a decanter, or a centrifugal to remove fine particles. Classification can be also performed to dried powder, but it is preferred to perform classification in liquid in light of efficiency.

Obtained unnecessary particulates or coarse particles can be returned to the mixing and kneading process for forming particles. At this point, wet particulates or coarse particles can be also returned thereto. The dispersion agent is preferably removed as much as possible at the same time with the classification process.

### External Additive

### (1) External Addition Treatment

The thus prepared toner mother particles after drying can be mixed with other particles of, for example, release agents, charge control agents, fluidizing agents and coloring materials. Such particles can be fixed on the toner particles by applying a mechanical impact thereto to integrate the particles with toner particles. Thus, the other particles can be prevented from being detached from the toner particles. Specific examples of such mechanical impact application methods include, but are not limited to, methods in which a mixture is mixed by a blade rotating at a high speed and methods in which a mixture is put into a jet air to collide the particles against each other or a collision plate.

Specific examples of such mechanical impact applicators include, but are not limited to, ONG MILL (manufactured by Hosokawa Micron Co., Ltd.), modified I TYPE MILL (manufactured by Nippon Pneumatic Mfg. Co., Ltd.) in which the pressure of air used for pulverization is reduced, HYBRIDIZATION SYSTEM (manufactured by Nara Machine Co., Ltd.), KRYPTRON SYSTEM (manufactured by Kawasaki Heavy Industries, Ltd.), automatic mortars, etc.

### (2) Fluidizer

To assist improving the fluidity and developability of a toner, inorganic particulates can be preferably used as a fluidizer. The primary particle diameter of such inorganic particulates is preferably from 5 to 100 nm and more preferably from 5 to 50 nm. The content of this inorganic particulate is preferably from 0.1 to 5.0% by weight, and more preferably from 0.5 to 3.0% by weight, based on the total weight of a toner. Specific preferred examples of such inorganic particulates include, but are not limited to, silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, rediron oxide, antimony trioxide, magnesium oxide, zirconium oxide, barium sulfate, barium carbonate, calcium carbonate, silicon carbide, and silicon nitride.

As other fluidizers, there can be used polymeric particulates, for example, copolymers of styrene, esters of methacryic acid, and esters of acrylic acid, which can be prepared by a soap-free emulsion polymerization method, a suspension polymerization method or a dispersion polymerization method, and polycondensation thermosetting resins, for example, silicone resins, benzoguanamine resins and nylon.

Such fluidizers can be subject to a surface treatment to improve hydrophobic property, thereby preventing deterioration of the fluidity and charging properties of a toner even in a high humid environment. Specific preferred examples of the surface preparation agents include, but are not limited to, silane coupling agents, silylation agents, silane coupling agents including a fluoroalkyl group, organic titanate coupling agents, aluminum coupling agents, silicone oil, and modified silicone oils.

The addition amount of such a fluidizer is from 0.6 to 5% by weight and preferably from 1 to 4 parts by weight based on 100 parts by weight of a toner.

### (3) Cleaning Helping Agent

As a cleaning helping agent that improves the cleaning property for removing residual toner remaining on an image bearing member or primary transfer medium after transfer, there can be used, for example, fatty acids and metal salts thereof, for example, zinc stearate, calcium stearate and stearic acid; resin particles which are prepared by a soap-free emulsion polymerization method or the like, for example, polymethyl methacrylate particles and polystyrene particles. The resin particles preferably have a narrow particle diameter distribution and the weight average particle diameter thereof is preferably from 0.01 to 1 μm.

### Charge Control Agent

A charge control agent may be included as a toner component of the present invention.

Specific examples of the charge control agent include known charge control agents, for example, Nigrosine dyes, triphenylmethane dyes, metal complex dyes including chromium, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid, metal salts of salicylic acid derivatives, etc. Specific examples of the marketed products of the charge control agents include, but are not limited to, BONTRON 03 (Nigrosine dyes), BONTRON P-51 (quaternary ammonium salt), BONTRON S-34 (metal-containing azo dye), E-82 (metal complex of oxynaphthoic acid), E-84 (metal complex of salicylic acid), and E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE (triphenyl methane derivative), COPY CHARGE NEG VP2036 and NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments and polymers having a functional group, for example, a sulfonate group, a carboxyl group and a quaternary ammonium group.

The content of the charge control agent is determined depending on the kind of the binder resin used, whether or not an additive is added, and the toner manufacturing method including the dispersion method and therefore is not simply specified. However, the content of the charge control agent is preferably from 0.1 to 10 parts by weight, and more preferably from 0.2 to 5 parts by weight based on 100 parts by weight of the binder resin included in the toner. When the content is too high, the toner tends to have too large chargeability, which leads to reduction in the effect of a main charge control agent, and thereby the electrostatic force with a developing roller increases, resulting in deterioration of the fluidity of the toner and a decrease of the image density of toner images. The charge control agent can be melted and kneaded together with a resin in a master batch. Also, these agents can be added to a master batch or can be directly added to an organic solvent when the toner component is dissolved or dispersed in the organic solvent. It is also possible to externally add such a charge control agent by a HENSCHEL MIXER.

### Analysis and Evaluation Method on Toner

Toner is analyzed and evaluated as follows.

### (1) Tensile Strength of Toner Agglomeration Body

Tensile strength of a toner is measured as follows: Fill a certain amount of toner in a cylindrical cell which can be divided approximately at the center by half for a top portion and a bottom portion; Compress the filled toner by a pressure of 1.1 kgf/cm² or 8 kgf/cm² to form a toner agglomeration body; Pull the both ends of the cell containing the toner agglomeration body; and measure the tensile strength (gf/cm²) of the toner agglomeration body at subsidiary fracture. The cell can be separated into the top cell and the bottom cell so that only the stress of a toner agglomeration body can be measured.

### Measuring Condition

Compression condition: Amount of toner filled: 5 g, Compression speed: 0.02 mm /sec., Holding time: 300 seconds
Tension test condition: Tension speed: 0.6 mm/sec, Measuring temperature: 45.0° C., Humidity: 50%
Compression/Tension characteristics measuring device: (AGROBOT ARG, manufactured by Hosokawa Micron Group)

### (2) Toner Particle Diameter and Particle Size Distribution

Toner particle diameter and toner particle size distribution are measured by Coulter Counter Method as follows: Add 0.1 to 5 ml of a surface active agent, preferably a salt of an alkyl benzene sulfonate, as a dispersant to 100 to 150 ml of an electrolytic aqueous solution, which is about 1% NaCl aqueous solution prepared by using primary NaCl and pure water, for example, ISOTON-II (manufactured by Beckman Coulter, Inc.) can be used; add 2 to 20 mg of a toner as a measuring sample to the electrolytic aqueous solution; Conduct dispersion treatment for the electrolytic aqueous solution in which the measuring sample is dispersed for about 1 to 3 minutes by a supersonic dispersion device; Measure the volume and the number of the toner particles or the toner by Coulter Counter with an aperture of 100 μm; and calculate the volume distribution and the number distribution. The weight average particle diameter (Dv) and the number average particle diameter (Dp) of the toner can be obtained based on the obtained distributions.

The whole range is a particle diameter of from 2.00 to not greater than 40.30 μm and the number of the channels is 13. Each channel is: from 2.00 to not greater than 2.52 μm; from 2.52 to not greater than 3.17 μm; from 3.17 to not greater than 4.00 μm; from 4.00 to not greater than 5.04 μm; from 5.04 to not greater than 6.35 μm; from 6.35 to not greater than 8.00 μm; from 8.00 to not greater than 10.08 μm; from 10.08 to not greater than 12.70 μm; from 12.70 to not greater than 16.00 μm, from 16.00 to not greater than 20.20 μm; from 20.20 to not greater than 25.40 μm; from 25.40 to not greater than 32.00 μm; and from 32.00 to not greater than 40.30 μm.

### Weight Average Molecular Weight

Coulter Counter TA-II or Coulter Multisizer II (both are manufactured by Beckman Coulter Co., Ltd.) can be used as the measuring device for toner particle diameter and particle size distribution by Coulter Counter Method.

### (3) Average Circularity

An optical detection method can be used for measuring particle forms in which particle images are optically detected by a charge coupled device (CCD) camera while a suspension containing particles passes through an imaging detective portion having a plate form. The average circularity of the particle is determined by dividing the circumferential length of the circle having the area equal to a projected toner area with the circumferential length of the projected toner area. This value is a value measured by a flow type particle image analyzer FPIA-2100 as the average circularity. The specific procedure for obtaining the average circularity is as follows:
1) A surface active agent serving as a dispersion agent, preferably 0.1 to 5 ml of an alkylbenzenesulfonic acid salt, is added to 100 to 150 ml of water from which solid impurities have been preliminarily removed;
2) About 0.1 to 0.5 g of a sample to be measured is added into the mixture prepared in (1);
3) The mixture prepared in (2) is subjected to an ultrasonic dispersion treatment for about 1 to 3 minutes such that the concentration of the particles is 3,000 to 10,000 particles per micro litter; and
4) The form and average particle diameter distribution of the sample are measured by the instrument mentioned above.
   (4) T1/2 (melting and fusing temperature in 1/2 method) Evaluation

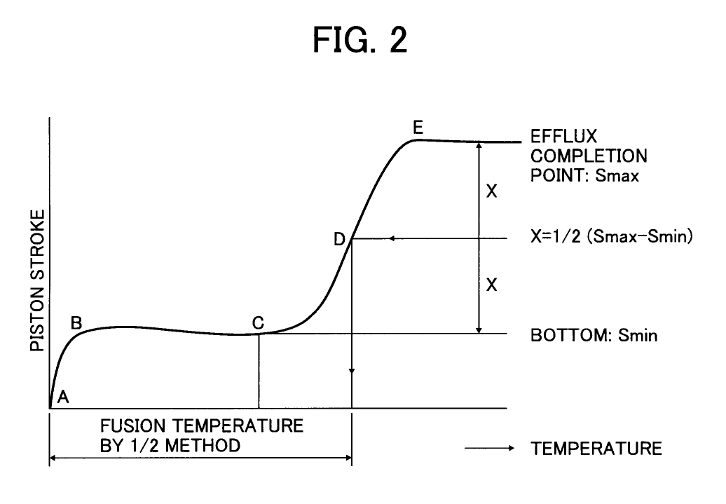

1/2 method for evaluating toner is to measure the temperature of a toner when 1/2 amount of the toner filled in a flow tester is melted by heating and flown from the efflux mouth. The flow curve of a toner by a flow tester is like a diagram illustrated in FIG. 2 and each temperature can be read from this curve. In FIG. 2, Tfb (Point C) is a temperature at which a toner starts flowing, D represents a temperature of T1/2 and E corresponds to a temperature at which the flow ends. A high elevated flow tester (CFT 500D type, manufactured by Shimadzu Corporation) can be used as a flow tester. The measuring conditions are as follows:

### Measuring Conditions:

Die diameter: 1.00 mm, Die length: 10.0 mm
Load: 5 Kg/cm², Speed of temperature rising: 3.0° C./min

### (5) Fogging Evaluation

Toner is evaluated on fogging as follows: Continuously print a predetermined print pattern having a B/W ratio of 6% in the N/N environment (23° C., 45%) using an external additive treated toner (development agent) and a printer (ipsio CX2500, manufactured by Ricoh Co., Ltd.); Subsequent to 2,000 continuous prints in the N/N environment (Durability test), attach a transparent adhesive tape to an uncleaned portion of an image bearing member to detach residual toner remaining thereon; Peel the transparent adhesive tape from the image bearing member to transfer the residual toner to the transparent adhesive tape; Attach the transparent adhesive tape to white paper; and visually observe the amount of residual toner for evaluation according to the following criteria.
G: Residual toner is observed little.
F: Residual toner is observed without a practical problem such that no fogging is observed on printed images.
B: Residual toner is observed and fogging is observed on printed images, which causes a practical problem.

### (6) Evaluation on Hollow Defects

Photocopied images having a solid band image having a width of 36 mm and photocopied images having a 4 dot fine line are printed by using an external additive treated toner (development agent) and a printer (ipsio CX2500, manufactured by Ricoh Co., Ltd.). The photocopied images are evaluated according to the following criteria:
G: No hollow defects occur in the photocopied image.
F: A few hollow defects are observed but do not make a practical problem.
B: Hollow defects are observed in many places, which makes a practical problem.

Having generally described preferred embodiments of this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

The present invention is specifically described with reference to Examples and Comparative Examples. The present invention is not limited to the embodiments described above and Examples and the embodiments can be altered or changed without departing the scope of the present invention.

### Example 1

### (1) Synthesis of Low Molecular Weight Polyester

The following components are contained in a reaction container equipped with a condenser, stirrer and a nitrogen introducing tube to conduct a reaction at 230° C. for 8 hours followed by another reaction with a reduced pressure of 10 to 15 mmHg for 5 hours:

| | |
|---|---|
| Adduct of bisphenol A with 2 mol of ethylene oxide | 220 parts |
| Bisphenol A with 3 mole of propylene oxide | 561 parts |
| Terephthalic acid | 218 parts |
| Adipic acid | 48 parts |
| Dibutyl tin oxide | 2 parts |

Forty five (45) parts of trimellitic anhydride are added in the container to conduct a reaction at 180° C. under normal pressure for 2 hours and Low molecular weight polyester resin 1 is obtained. The number average molecular weight (Mn) of Low molecular weight polyester resin 1 is 2,500, the weight average molecular weight (Mw) thereof is 6,700, the glass transition temperature (Tg) thereof is 43° C. and the acid value thereof is 25.

### (2) Synthesis of Prepolymer

The following components are contained in a container equipped with a condenser, a stirrer and a nitrogen introducing tube to conduct a reaction at 230° C. at normal pressure for 8 hours followed by another reaction for 5 hours with a reduced pressure of 10 to 15 mmHg to obtain Intermediate body polyester 1:

| | |
|---|---|
| Adduct of bisphenol A with 2 mole of ethylene oxide | 682 parts |
| Adduct of bisphenol A with 2 mole of propylene oxide | 81 parts |
| Terephthalic acid | 283 parts |
| Trimellitic anhydrate | 22 parts |
| Dibutyl tin oxide | 2 parts |

The obtained Intermediate body polyester 1 has a number average molecular weight of 2,100, a weight average molecular weight of 9,500, a glass transition temperature of 55° C., an acid value of 0.5 mgKOH/g and a hydroxyl value of 49 mgKOH/g.

Next, the following components are contained in a container equipped with a condenser, a stirrer and a nitrogen introducing tube to conduct a reaction at 100° C. for 5 hours to obtain Prepolymer 1:

| | |
|---|---|
| Intermediate body polyester 1 | 411 parts |
| Isophorone diisocyanate | 89 parts |
| Ethyl acetate | 500 parts |

Prepolymer 1 has an isolated isocyanate weight % of 1.53%.

### (3) Synthesis of Master Batch

The following is mixed by a HENSCHEL MIXER to obtain a mixture in which water is soaked in a pigment agglomeration body.

| | |
|---|---|
| Carbon black (REGUL 400R, manufactured by Cabot | 50 parts |
| Corporation) | |
| Binder resin: Polyester resin (manufactured by SanyoKasei Co., | 50 parts |
| Ltd., acid value: 10, Mw: 20,000, Tg: 64° C.) | |
| Water | 30 parts |

The mixture is mixed and kneaded for 45 minutes by a two-roll with the surface temperature of the rolls of 130° C. The resultant is pulverized by a pulverizer to a size of 1 mm φ to obtain Master batch 1.

### (4) Manufacturing of Liquid Dispersion (Oil Phase) of Pigment and Wax

The following is placed and mixed in a reaction container equipped with a stirrer and a thermometer:

| | |
|---|---|
| Low molecular weight polyester 1 | 378 parts |
| Paraffin wax | 127 parts |
| Wax dispersion agent described in JOP 2004-246345 | 127 parts |
| Ethyl acetate | 947 parts |

The mixture is agitated, heated to 80° C., and kept at 80° C. for 5 hours and then cooled down to 30° C. in 1 hour. Then, 500 parts of Master batch 1 and 500 parts of ethyl acetate are added to the reaction container and mixed for 1 hour to obtain Liquid material 1.

Then, 1,324 parts of Liquid material 1 is transferred to a reaction container and dispersed using a bead mill (ULTRAVISCOMILL from AIMEX) under the following conditions to disperse the carbon black and the wax:
Liquid feeding speed: 1 kg/hr,
Disc rotation speed: 6 m/sec,
Diameter of zirconia beads: 0.5 mm,
Filling factor: 80% by volume, and
Repeat number of dispersion treatment: 3 times.

Next, 1,324 parts of Low molecular weight polyester 1 of 65% by weight of ethyl acetic acid solution are added to the container. After 1 pass of the bead mill under the same condition mentioned above, Pigment wax liquid dispersion 1 is obtained. Ethyl acetate is added to adjust the density of the solid portion of Pigment wax liquid dispersion 1 to be 50%.

### (5) Preparation of Aqueous Medium

953 parts of water, 88 parts of a 25% aqueous solution of a vinyl based resin (Copolymer of sodium salt of an adduct of sulfate with styrene—methacrylic acid—acrylic butylate—ethylene oxide methacrylate), 90 parts of a 48.5% aqueous solution of sodium dodecyldiphenyletherdisulfonate (EREMINOR MON-7 manufactured by Sanyo Chemical Industries, Ltd.), 113 parts of ethyl acetate and 11.2 parts of potassium persulfate as a radical generation agent are mixed and stirred and a milk white liquid (Aqueous phase 1) is obtained.

### (6) Emulsification Process

976 parts of Pigment wax liquid dispersion 1 and 6.0 parts of isophorone diamine as an amine are placed in a container and mixed for one minute by a TK HOMOMIXER (manufactured by Tokushu Kika Kogyo Co., Ltd.) at a rotation of 5,000 rpm. 137 parts of Prepolymer 1 is added followed by mixing for one minute by a TK HOMOMIXER (manufactured by Tokushu Kika Kogyo Co., Ltd.) at a rotation of 5,000 rpm. Then, 1,200 parts of Aqueous phase 1 are added thereto followed by mixing for 15 minutes by a TK HOMOMIXER (manufactured by Tokushu Kika Kogyo Co., Ltd.) at a rotation of 3,000 rpm. Thus, Emulsion slurry 1 is prepared.

### (7) Removal of Solvent

In a container equipped with a stirrer and a thermometer, Emulsion slurry 1 is set and heated at 30° C. for 8 hours to remove the solvents therefrom. Subsequent to aging at 60° C. for 10 hours, Slurry dispersion 1 is obtained.

### (8) Washing and Drying

One hundred (100) parts of Emulsion slurry 1 are filtered under a reduced pressure. Then, the following operations are performed.
(a) 100 parts of deionized water are added to the thus prepared filtered cake and the mixture is mixed for 10 minutes by a TK HOMOMIXER at a revolution of 12,000 rpm and then filtered to obtain a filtered cake;
(b) 900 parts of deionized water are added to the filtered cake prepared in (a) and the resultant is mixed for 30 minutes by a TK HOMOMIXER at a rotation of 12,000 rpm while applying supersonic vibration thereto, and then filtered under a reduced pressure. This operation is repeated until the electric conductivity of the reslurry liquid is not greater than 10 μC/cm;
(c) 10% hydrochloric acid is added to the reslurry liquid prepared in (b) to make pH of the reslurry liquid to be 4 followed by stirring by a three-one motor for 30 minutes and filtering. Thus, a filtered cake is obtained;
(d) 100 parts of deionized water are added to the cake prepared in (c) and the resultant is mixed for 10 minutes by a TK HOMOMIXER at a rotation of 12,000 rpm followed by filtering. This operation is repeated until the electric conductivity of the reslurry liquid is not greater than 10 μC/cm. Thus, Filtered cake 1 is obtained.

Filtered cake 1 is dried at 45° C. for 48 hours using a circulating drier. The dried cake is sieved using a screen having openings of 75 μm. Thus, Mother toner 1 is obtained. The volume average particle diameter (Dv) is 5.6 μm, the average circularity is 0.97 and T1/2 is 127° C. Next, 2 parts of silica (NAX) is added to 100 parts of this Mother toner. The mixture is mixed by a HENSCEL MIXER at a circumferential velocity of 40 (m/s) for 120 seconds. Thus, the toner (non-magnetic single component development toner) of the present invention is obtained. This toner is used in Example 1. The characteristics and the evaluation results thereof are shown in Table 1.

### Examples 2 to 6 and Comparative Examples 1 to 3

Toners of Examples 2 to 6 and Comparative Examples 1 to 3 are manufactured by adding external additives shown in Table 1 to the Mother toner obtained as in the same manner described in Example 1. The characteristics and the evaluation results thereof are shown in Table 1.

### Example 7

Mother toner of Example 7 is manufactured in the same manner as in Example 1 except that the amount of 48.5% aqueous solution of sodium dodecyldiphenylether disulfonate (EREMINOR MON-7 manufactured by Sanyo Chemical Industries, Ltd.) is changed from 90 parts to 80 parts in (5) Preparation of Aqueous Medium of Example 1. With regard to the Mother toner, the volume average particle diameter (Dv) is 6.2 μm, the average circularity is 0.97 and T1/2 is 126° C. Next, 2 parts of NAX50 is added to 100 parts of this Mother toner. The mixture is mixed by a HENSCEL MIXER at a circumferential velocity of 40 (m/s) for 120 seconds. Thus, the toner of Example 7 is obtained. The characteristics and the evaluation results thereof in terms of a non-magnetic single component development system are shown in Table 1.

### Example 8

Mother toner of Example 8 is manufactured in the same manner as in Example 1 except that the addition amount of isophorone diamine is changed from 6.0 parts to 4.6 parts and the addition amount of Prepolymer 1 is changed from 137 parts to 104 parts in (6) Emulsification process of Example 1. With regard to the Mother toner, the volume average particle diameter (Dv) is 5.4 μm, the average circularity is 0.97 and T1/2 is 120° C. Next, 2 parts of NAX50 is added to 100 parts of this Mother toner. The mixture is mixed by a HENSCEL MIXER at a circumferential velocity of 40 (m/s) for 120 seconds. Thus, the toner of Example 8 is obtained. The characteristics and the evaluation results thereof in terms of a non-magnetic single component development system are shown in Table 1.

### Comparative Example 4

Mother toner of Comparative Example 4 is manufactured in the same manner as in Example 1 except that the addition amount of isophorone diamine is changed from 6.0 parts to 4.0 parts and the addition amount of Prepolymer 1 is changed from 137 parts to 93 parts in (6) Emulsification process of Example 1. With regard to the Mother toner, the volume average particle diameter (Dv) is 5.3 μm, the average circularity is 0.98 and T1/2 is 118° C. Next, 2 parts of NAX50 is added to 100 parts of this Mother toner. The mixture is mixed by a HENSCEL MIXER at a circumferential velocity of 40 (m/s) for 120 seconds. Thus, the toner of Comparative Example 4 is obtained. The characteristics and the evaluation results thereof in terms of a non-magnetic single component development system are shown in Table 1.

### Comparative Examples 5 and 6

Toners for use in a typical printer in the market are used as toners of Comparative Examples 5 and 66 and the characteristics and the evaluation results thereof are shown in Table 1 as in Example 1.
Comparative 5: toner filled in the cartridge for use in LBP 5500 (manufactured by Canon Inc.) (toner manufactured by a suspension polymerization method. D4=6.8 μm (according to the value in the catalogue thereof)
Comparative Example 6: toner filled in the cartridge for use in Docu Print 2425 (manufactured by Xerox Corporation) (spherical toner manufactured by an emulsification agglomeration method. D4=6.5 μm (according to the value in the catalogue thereof). The characteristics and the evaluation results thereof are shown in Table 1.

TABLE 1

| | External Additive | | | | | | | | | | | |
|---|---|---|---|---|---|---|---|---|---|---|---|---|
| | | Inorganic | | | | | | | | | | |
| | | particulates | | | | | | | | | Hollow | |
| | | Particle | Addition | Mixing | Toner | | | AGROBOT ARG | | | defects | |
| | Product | diameter | amount | time | particle | | | 1.1 | 8 | | Fine | Solid |
| | Name | (nm) | (%) | (sec) | diameter | Form | T½ | (kg/cm³) | (kg/cm³) | Fogging | line | image |
| Example 1 | (silica) | 35 | 2 | 120 | 5.6 | 0.97 | 127 | 12 | 30 | G | G | G |
| | NAX50 | | | | | | | | | | | |
| Example 2 | (silica) | 25 | 2 | 120 | 5.6 | 0.97 | 127 | 15 | 35 | G | G | G |
| | NX90 | | | | | | | | | | | |
| Example 3 | (silica) | 25 | 2 | 200 | 5.6 | 0.97 | 127 | 22 | 44 | F | G | G |
| | NAX50 | | | | | | | | | | | |
| Example 4 | (silica) | 25 | 3 | 120 | 5.6 | 0.97 | 127 | 18 | 38 | G | G | G |
| | NAX50 | | | | | | | | | | | |
| Example 5 | (silica) | 25 | 1 | 120 | 5.6 | 0.97 | 127 | 16 | 39 | G | G | G |
| | NAX50 | | | | | | | | | | | |
| Example 6 | (silica) | 7 | 1 | 120 | 5.6 | 0.97 | 127 | 10 | 33 | G | G | F |
| | TG811F | | | | | | | | | | | |
| | (silica) | 35 | 1 | | | | | | | | | |
| | NAX50 | | | | | | | | | | | |
| Example 7 | (silica) | 35 | 2 | 120 | 6.2 | 0.98 | 125 | 11 | 25 | G | G | F |
| | NAX50 | | | | | | | | | | | |
| Example 8 | (silica) | 35 | 2 | 120 | 5.4 | 0.97 | 120 | 19 | 42 | F | F | G |
| | NAX50 | | | | | | | | | | | |
| Comparative | (silica) | 7 | 2 | 120 | 5.6 | 0.97 | 127 | 23.7 | 52.6 | B | B | F |
| Example 1 | TG811F | | | | | | | | | | | |
| Comparative | (silica) | 110 | 2 | 120 | 5.6 | 0.97 | 127 | 27.5 | 49.9 | B | B | B |
| Example 2 | X24 | | | | | | | | | | | |
| Comparative | (silica) | 25 | 0.05 | 180 | 5.6 | 0.97 | 127 | 24.2 | 48.5 | B | B | B |
| Example 3 | NX90 | | | | | | | | | | | |
| Comparative | (silica) | 35 | 1 | 120 | 5.3 | 0.98 | 118 | 21.5 | 49.7 | B | B | G |
| Example 4 | NAX50 | | | | | | | | | | | |
| Comparative | Market | | | | | | | 11.7 | 20.5 | G | G | B |
| Example 5 | Product | | | | | | | | | | | |
| Comparative | Market | | | | | | | 15.4 | 42.5 | B | B | B |
| Example 6 | Product | | | | | | | | | | | |

This document claims priority and contains subject matter related to Japanese Patent Application No. 2007-011723, filed on Jan. 22, 2007, the entire contents of which are incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the Untied States is:

1. A toner comprising:
a coloring material;
a binder resin; and
an external additive,
wherein a tensile strength A of a toner agglomeration body compressed at a compression force of 1.1 kgf/cm² is from 10 to 25 gf/cm² and a tensile strength B of a toner agglomeration body compressed at a compression force of 8 kgf/cm² is from 25 to 45 gf/cm² and the tensile strength A and the tensile strength B satisfy the following relationship: (Tensile strength B)−(Tensile strength A)≦25 gf/m².

2. The toner according to claim 1, wherein the binder resin comprises a polyester based resin having a glass transition temperature of not lower than 40° C.

3. The toner according to claim 1, wherein the binder resin comprises a polyester resin having at least one of a urea linkage and a urethane linkage in a molecule thereof.

4. The toner according to claim 1, wherein the binder resin comprises a polyester resin formed by reaction between a modified polyester prepolymer having an isocyanate group at an end of a molecular thereof and an amine.

5. The toner according to claim 1, wherein the toner has an average circularity of from 0.95 to 0.99 and a volume average particle diameter of from 4 to less than 8 μm.

6. The toner according to claim 1, further comprising at least one releasing agent selected from the group consisting of paraffin waxes, synthesized ester waxes, polyolefin waxes, carnauba wax, and rice wax.

7. The toner according to claim 1, wherein the toner is for a single component development toner.

8. A method of manufacturing the toner of claim 1 comprising:
mixing an oil phase in which at least the coloring agent and at least one of the binder resin and a precursor thereof dissolved or dispersed in an organic solvent in an aqueous medium for granulating particles; and then
removing the organic solvent.

9. The method of manufacturing the toner of claim 1 according to claim 8, further comprising washing the particles with an aqueous medium for washing followed by drying.

10. A toner supply cartridge detachably attached to an image forming apparatus, the toner supply cartridge being configured to contain the toner of claim 1 and supply the toner to a toner transfer portion in a development device which forms a toner image on a surface of an image bearing member of the image forming apparatus.

11. A process cartridge comprising:
an image bearing member;
a charging device configured to charge a surface of the image bearing member; and
a development device configured to develop a latent image formed by scanning the surface of the charged image bearing member with light,
wherein the toner supply cartridge of claim 10 is detachably attached to the development device.

12. An image forming apparatus comprising:
an image bearing member configured to bear a latent image on a surface thereof;
a charging device configured to charge the surface of the image bearing member;
an irradiation device configured to irradiate the surface of the image bearing member with light and form the latent image thereon;
a development device configured to develop the latent image with the toner of claim 1 and visualize the latent image;
a transfer device configured to transfer the visualized image to a recording medium; and
a cleaning device configured to clean the surface of the image bearing member.

13. The image forming apparatus according to claim 12, further comprising the toner supply cartridge of claim 10 or the process cartridge of claim 11.

14. The image forming apparatus according to claim 13, further comprising an intermediate transfer device having an endless form.
